(19) United States
(12) Patent Application Publication
(10) Pub. No.: US 2020/0043254 A1
(43) Pub. Date: Feb. 6, 2020

(54) DATA STORAGE DEVICE OF VEHICLE

(71) Applicant: DENSO CORPORATION, Kariya-city (JP)

(72) Inventors: Tomomi HASE, Kariya-city (JP); Noriaki IKEMOTO, Kariya-city (JP); Mitsuharu HIGASHITANI, Kariya-city (JP)

(73) Assignee: DENSO CORPORATION, Kariya-city (JP)

(21) Appl. No.: 16/599,225

(22) Filed: Oct. 11, 2019

Related U.S. Application Data
(63) Continuation of application No. PCT/JP2018/008114, filed on Mar. 2, 2018.

(30) Foreign Application Priority Data
Apr. 11, 2017 (JP) 2017-078138

(51) Int. Cl. G07C 5/08

(52) U.S. Cl. CPC G07C 5/085; G05D 1/0088; G07C 5/0808

(57) ABSTRACT

A data storage device is mounted on a vehicle on which an autonomous driving control device performs an autonomous driving control. The data storage device includes an abnormality detector and a controller. The abnormality detector detects an abnormal state including at least one of an abnormality in an occupant of the vehicle and an abnormality in the surrounding environment of the vehicle. When the abnormality detector detects the abnormal state, the controller causes a storage medium to store determination information allowing for determination of whether a subject driving the vehicle is the autonomous driving control device. The determination information includes at least one of a control amount of the autonomous driving control, basis information for the control amount, an operation amount of the vehicle, actual output information of the vehicle, and information directly indicating whether autonomous driving is ON.

### CROSS-REFERENCE TO RELATED APPLICATIONS

The present application is a continuation application of International Application No. PCT/JP2018/008114, filed Mar. 2, 2018, which claims priority to Japanese Patent Application No. 2017-078138, filed Apr. 11, 2017. The contents of these applications are incorporated herein by reference in their entirety.

### BACKGROUND

### Technical Field

The present disclosure relates to a data storage device of a vehicle.

### Related Art

In related techniques, an in-vehicle device transmits an emergency imaging request signal to the outside of a vehicle when detecting an abnormality in the behavior of the vehicle based on the detection result of a sensor. The in-vehicle device stores, into a memory, data of an image captured by an in-vehicle camera. When receiving an emergency imaging request signal from the outside of the vehicle, the in-vehicle device transmits, to an accident analysis server, image data stored during a predetermined period of time before and after the reception.

### SUMMARY

One aspect of the present disclosure provides a data storage device mounted on a vehicle on which an autonomous driving control device performs an autonomous driving control. The data storage device includes an abnormality detector and a controller. The abnormality detector detects an abnormal state including at least one of an abnormality in an occupant of the vehicle and an abnormality in the surrounding environment of the vehicle. When the abnormality detector detects an abnormal state, the controller causes a storage medium to store determination information allowing for determination of whether the subject driving the vehicle is the autonomous driving control device. The determination information includes at least one of a control amount of the autonomous driving control, basis information for the control amount, an operation amount of the vehicle, actual output information of the vehicle, and information directly indicating whether autonomous driving is ON.

### BRIEF DESCRIPTION OF THE DRAWINGS

In the accompanying drawings:

FIG. 1 is a block diagram showing a schematic configuration of a vehicle according to the first embodiment;

FIG. 2 is a block diagram showing a schematic configuration of a data storage device according to the first embodiment;

FIG. 3 is a flowchart showing the flow of a process performed by a controller according to the first embodiment;

FIG. 4 is a chart showing specific details of information related to autonomous driving according to the first embodiment;

FIG. 5 is a chart showing specific details of information related to manual driving according to the first embodiment;

FIG. 6 is a chart showing specific details of management information according to the first embodiment;

FIG. 7 is a chart showing specific details of information of a travel mode of a vehicle according to the first embodiment;

FIG. 8 is a timing chart showing, in (A) and (B), transition of data stored in a regular storage medium and a saving storage medium according to the first embodiment;

FIG. 9 is a timing chart showing, in (A) and (B), transition of data stored in the regular storage medium and the saving storage medium according to the first embodiment;

FIG. 10 is a block diagram showing a schematic configuration of a data storage device according to the first variation of the first embodiment;

FIG. 11 is a block diagram showing a schematic configuration of a data storage device according to the second variation of the first embodiment;

FIG. 12 is a timing chart showing, in (A) and (B), transition of data stored in a regular storage medium and a saving storage medium according to the third variation of the first embodiment;

FIG. 13 is a timing chart showing, in (A) and (B), transition of data stored in a regular storage medium and a saving storage medium according to the fourth variation of the first embodiment;

FIG. 14 is a timing chart showing, in (A) and (B), transition of data stored in a regular storage medium and a saving storage medium according to the fifth variation of the first embodiment;

FIG. 15 is a timing chart showing, in (A) to (C), transition of data stored in a regular storage medium, a first saving storage medium, and a second saving storage medium according to the sixth variation of the first embodiment;

FIG. 16 is a timing chart showing, in (A) and (B), transition of data stored in a regular storage medium and a saving storage medium according to the seventh variation of the first embodiment;

FIG. 17 is a timing chart showing, in (A) and (B), transition of data stored in a regular storage medium and a saving storage medium according to the eighth variation of the first embodiment;

FIG. 18 is a timing chart showing, in (A) and (B), transition of data stored in the regular storage medium and the saving storage medium according to the eighth variation of the first embodiment;

FIG. 19 is a block diagram showing a schematic configuration of a data storage device according to the ninth variation of the first embodiment;

FIG. 20 is a timing chart showing transition of data stored in a regular storage medium according to the ninth variation of the first embodiment;

FIG. 21 is a timing chart showing, in (A) and (B), transition of data stored in a regular storage medium and a saving storage medium according to the tenth variation of the first embodiment;

FIG. 22 is a timing chart showing, in (A) and (B), transition of data stored in a regular storage medium and a saving storage medium according to the eleventh variation of the first embodiment;

FIG. 23 is a chart showing details of actual output information of a vehicle according to the twelfth variation of the first embodiment;

FIG. 24 is a timing chart showing, in (A) and (B), transition of data stored in a regular storage medium and a saving storage medium according to the thirteenth variation of the first embodiment;

FIG. 25 is a timing chart showing, in (A) and (B), transition of data stored in the regular storage medium and the saving storage medium according to the thirteenth variation of the first embodiment;

FIG. 26 is a chart showing the relationship between an abnormality type, an abnormal portion, an example of an expected control, an example of time until the control becomes stable, and an example of a sampling period according to the thirteenth variation of the first embodiment;

FIG. 27 is a chart showing the relationship between an abnormality type, an abnormal portion, an example of an expected control, an example of time until the control becomes stable, and an example of a sampling period according to the thirteenth variation of the first embodiment;

FIG. 28 is a flowchart showing the flow of a process performed by a controller according to the second embodiment;

FIG. 29 is a diagram schematically showing an example of an operation of a vehicle according to the second embodiment;

FIG. 30 is a diagram schematically showing an example of the operation of the vehicle according to the second embodiment;

FIG. 31 is a flowchart showing the flow of a process performed by a controller according to the second variation of the second embodiment;

FIG. 32 is a diagram schematically showing an example of an operation of a vehicle according to the second variation of the second embodiment;

FIG. 33 is a flowchart showing the flow of a process performed by a controller according to the third embodiment; and

FIG. 34 is a flowchart showing the flow of a process performed by a controller according to the fourth embodiment.

### DESCRIPTION OF THE EMBODIMENTS

JP-A-2009-205368 discloses an in-vehicle device that when detecting an abnormality in the behavior of the vehicle on the basis of the detection result of a sensor, transmits an emergency imaging request signal to the outside of a vehicle. The in-vehicle device stores, into a memory, data of an image captured by an in-vehicle camera. When receiving an emergency imaging request signal from the outside of the vehicle, the in-vehicle device transmits, to an accident analysis server, image data stored during a predetermined period of time before and after the reception. Thus, even in the case where the vehicle including the in-vehicle device has an accident, as long as the emergency imaging request signal has been transmitted, image data can be transmitted from another vehicle including the in-vehicle device to the accident analysis server.

In a vehicle capable of autonomous driving, when some abnormality occurs in the vehicle, there are cases where the cause of the abnormality is analyzed afterwards. The abnormality in the vehicle includes not only an actual vehicle abnormality, but also vehicle behavior that a driver feels is abnormal. In the vehicle capable of autonomous driving, the subject driving the vehicle switches between a control device and a person. For example, the subject driving the vehicle is the control device in a situation in which autonomous driving is permitted, and is a person in a situation in which autonomous driving is not permitted. Therefore, whether the subject driving the vehicle upon the occurrence of an abnormality is the control device or a person needs to be determined as one issue to be analyzed for the cause of the abnormality.

With the in-vehicle device disclosed in JP-A-2009-205368, when some abnormality occurs in a vehicle, data of an image captured by the in-vehicle camera is stored into the memory, and such image data is transmitted to the accident analysis server. However, whether the subject driving the vehicle upon the occurrence of an abnormality is the control device or a person is difficult to identify only by analyzing the image data stored in the memory or the image data transmitted to the accident analysis server.

It is thus desired to provide a data storage device of a vehicle capable of autonomous driving and capable of analyzing whether a subject driving the vehicle upon the occurrence of an abnormality is a person or a control device.

An exemplary embodiment of the present disclosure provides a data storage device mounted on a vehicle on which an autonomous driving control device performs an autonomous driving control. The data storage device includes an abnormality detector and a controller. The abnormality detector detects an abnormal state including at least one of an abnormality in an occupant of the vehicle and an abnormality in the surrounding environment of the vehicle. When the abnormality detector detects an abnormal state, the controller causes a storage medium to store determination information allowing for determination of whether the subject driving the vehicle is the autonomous driving control device. The determination information includes at least one of a control amount of the autonomous driving control, basis information for the control amount, an operation amount of the vehicle, actual output information of the vehicle, and information directly indicating whether autonomous driving is ON.

Alternatively, the abnormality detector predicts an abnormality in the vehicle. When the abnormality detector predicts entry into an abnormal state, the controller causes the storage medium to store determination information allowing for determination of whether the subject driving the vehicle is the autonomous driving control device.

With these configurations, when some abnormality occurs in the vehicle or when it is predicted that an abnormality will occur, the determination information is stored into the storage medium. Therefore, whether the subject driving the vehicle upon the occurrence of an abnormality is a person or the autonomous driving control device can be analyzed by analyzing the determination information stored in the storage medium.

Hereinafter, embodiments of a data storage device of a vehicle will be described with reference to the drawings. In order to facilitate understanding of the description, the same structural elements in the drawings share the same reference signs wherever possible, and overlapping description is omitted.

### First Embodiment

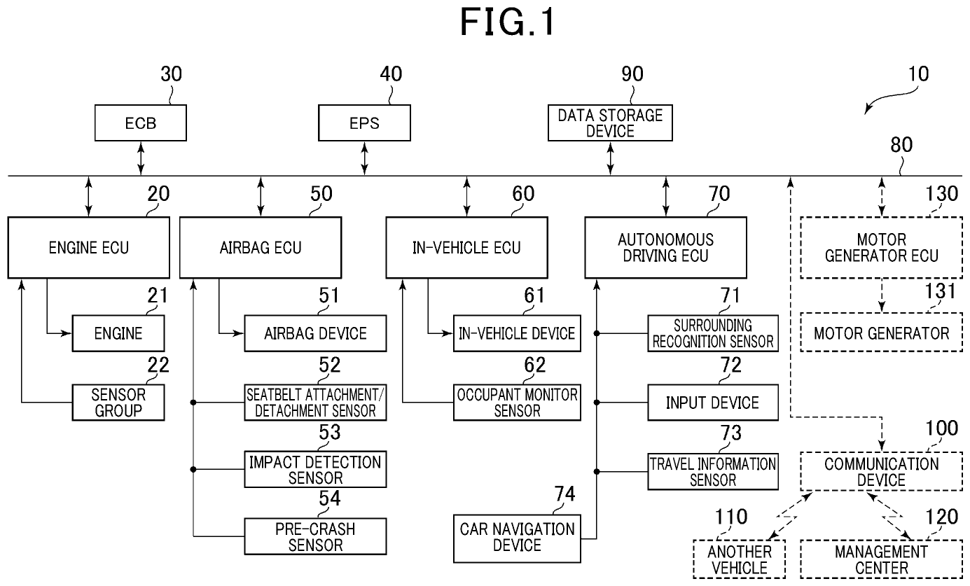

First, a schematic configuration of a vehicle on which a data storage device according to the present embodiment is mounted will be described. As shown in FIG. 1, a vehicle 10 according to the present embodiment includes, as control devices for performing various controls of the vehicle, an engine electronic control unit (ECU) 20, an electronic control brake system 30, an electric power steering system 40, an airbag ECU 50, an in-vehicle ECU 60, an autonomous driving ECU 70, and the like. These ECUs are each configured mainly using a microcomputer including a central processing unit (CPU), a read-only memory (ROM), a random-access memory (RAM), and the like. Furthermore, these ECUs are connected via an in-vehicle network 80 so as to be able to communicate with one another. In the following description, the electronic control brake system 30 is abbreviated as “ECB 30”, and the electric power steering system 40 is abbreviated as “EPS 40”.

The engine ECU 20 is a portion that performs what is called engine control in which an engine 21 which generates power for driving the vehicle 10 is integrally controlled. Specifically, the engine ECU 20 receives an output signal of an engine-based sensor group 22. The engine-based sensor group 22 detects a vehicle status quantity required to perform the engine control and outputs, to the engine ECU 20, a signal corresponding to the detected vehicle status quantity. The vehicle status quantity required to control the engine includes, for example, the travel speed of the vehicle, the temperature of an engine coolant, depression of an accelerator pedal, and the amount of intake air. The engine ECU 20 detects various vehicle status quantities on the basis of output signals of the engine-based sensor group 22, and performs various controls of the engine 21 such as a fuel injection control and an ignition timing control on the basis of the detected vehicle status quantities.

The ECB 30 integrally controls brake systems of the vehicle. For example, the ECB 30 performs what is called an anti-lock braking control in which when a driver steps on the brake pedal, braking force to be applied to wheels is optimally distributed according to the rotational speed, turning, etc., of each of the front wheels and the rear wheels of the vehicle 10. Furthermore, the ECB 30 performs an automatic brake control on the basis of a request from the autonomous driving ECU 70 via the in-vehicle network 80. The automatic brake control is to automatically apply braking force to each wheel of the vehicle independently of a driver's operation of stepping on the brake pedal.

The EPS 40 performs what is called an assist control in which assist torque corresponding to steering torque applied to the steering wheel of the vehicle 10 is applied to the steering wheel to assist steering of a driver. Furthermore, the EPS 40 performs an automatic steering control on the basis of a request from the autonomous driving ECU 70 via the in-vehicle network 80. The automatic steering control is to apply torque to the steering shaft, etc., of the vehicle so that the steering angle of the vehicle 10 automatically changes independently of driver's steering of the steering wheel.

The airbag ECU 50 controls the airbag device 51 mounted on the vehicle. Specifically, the airbag ECU 50 receives output signals of a seatbelt attachment/detachment sensor 52, an impact detection sensor 53, and a pre-crash sensor 54. The seatbelt attachment/detachment sensor 52 detects whether an occupant of the vehicle 10 wears a seatbelt, and outputs a signal corresponding to the detection result. The impact detection sensor 53 includes an acceleration sensor or the like, detects impact force exerted on the vehicle 10 upon collision of the vehicle, and outputs a signal corresponding to the detected impact force. The pre-crash sensor 54 includes a camera, a radar sensor, and the like, detects a situation in which collision between the vehicle 10 and an obstacle is imminent, and outputs a signal corresponding to the detection result. The airbag ECU 50 determines, on the basis of the output signal of each of these sensors 52 to 54, whether the airbag device 51 needs to be actuated, and when determining that the airbag device 51 needs to be actuated, drives the airbag device 51 to inflate a bag body. Thus, the occupant of the vehicle 10 is protected from the impact.

The in-vehicle ECU 60 is collection of a plurality of ECUs other than the ECUs 20, 30, 40, 50, 70, and controls various in-vehicle devices 61. The in-vehicle ECU 60 receives an output signal of an occupant monitor sensor 62. The occupant monitor sensor 62 detects the state of an occupant in the vehicle interior and transmits information about the detected state of the occupant to the in-vehicle ECU 60. The information detected by the occupant monitor sensor 61 includes, for example, information indicating whether the driver is intoxicated and information indicating whether the driver is unconscious. As the occupant monitor sensor 62, a camera that captures an image of the vehicle interior, an infrared sensor capable of detecting the body temperature of an occupant, and a microphone that acquires sound in the vehicle interior can be used, for example. In response to requests from the other ECUs 20, 30, 40, 50, 70, the in-vehicle ECU 60 transmits, to these ECUs, the information about the state of the occupant detected by the occupant monitor sensor 62.

The autonomous driving ECU 70 is a portion that performs what is called an autonomous driving control in which autonomous driving of the vehicle 10 is integrally controlled. In the present embodiment, the autonomous driving ECU 70 is equivalent to the autonomous driving control device. The autonomous driving ECU 70 can communicate with the engine ECU 20, the ECB 30, the EPS 40, the airbag ECU 50, and the like via the in-vehicle network 80 to acquire information acquired by these ECUs.

Furthermore, output signals of a surrounding recognition sensor 71, an input device 72, and a travel information sensor 73 are input to the autonomous driving ECU 70.

The surrounding recognition sensor 71 detects an object present in a predetermined range that is set around the vehicle 10, such as a predetermined range in front of the vehicle 10 and a predetermined range behind the vehicle 10, and outputs, to the autonomous driving ECU 70, a signal corresponding to the detected object. The surrounding recognition sensor 71 includes, for example, a camera and a lidar device. On the basis of the output signal of the surrounding recognition sensor 71, the autonomous driving ECU 70 detects an object present around the vehicle 10.

The input device 72 is a portion that is operated by a driver of the vehicle 10. The input device 72 includes, for example, an operation switch which is operated to start and stop autonomous driving. The input device 72 outputs, to the autonomous driving ECU 70, a signal corresponding to an operation of the driver. On the basis of the output signal of the input device 72, the autonomous driving ECU 70 detects the operation performed by the driver on the input device 72.

The travel information sensor 73 detects the travel state of the vehicle 10. The travel information sensor 73 includes, for example, a vehicle speed sensor which detects the travel speed of the vehicle and an angular speed sensor which detects the angular speed of the vehicle. The travel information sensor 73 detects a travel status quantity of the vehicle 10 and outputs, to the autonomous driving ECU 70, a signal corresponding to the detected travel information quantity of the vehicle 10.

Furthermore, the autonomous driving ECU 70 is connected to a car navigation device 78 of the vehicle 10 so as to be able to communicate with each other. The autonomous driving ECU 70 is capable of acquiring, from the car navigation device 78, information about a travel path such as the slope and curvature of a road on which the vehicle 10 may travel in the future.

The autonomous driving ECU 70 performs an autonomous driving control on the basis of various kinds of information acquired from the ECUs 20, 30, 40, 50, 60, the surrounding recognition sensor 71, the input device 72, the travel information sensor 73, the car navigation device 78, and the like. Specifically, when detecting, on the basis of the output signal of the input device 72, that the driver has performed the operation to start autonomous driving, the autonomous driving ECU 70 starts the autonomous driving control. The autonomous driving ECU 70 according to the present embodiment automatically controls a power system of the vehicle 10 which includes the engine 21 and a transmission, a brake system of the vehicle 10 which includes the ECB 30, and a steering system of the vehicle which includes the EPS 40, as the autonomous driving control. Hereinafter, the state of the vehicle 10 under the autonomous driving control by the autonomous driving ECU 70 will be referred to as an “autonomous drive mode”. The state of the vehicle 10 not under the autonomous driving control by the autonomous driving ECU 70, in other words, the state of the vehicle 10 that is being manually operated by the driver, will be referred to a “manual drive mode”.

For example, using the surrounding recognition sensor 71, the autonomous driving ECU 70 detects a lane boundary in front of the vehicle, a preceding vehicle, or an obstacle that impedes travel of the vehicle 10. Furthermore, the autonomous driving ECU 70 detects the travel state of the vehicle using the travel information sensor 73. The autonomous driving ECU 70 sets a target travel line for the vehicle 10 on the basis of information of the detected lane boundary in front of the vehicle, the detected preceding vehicle, the detected obstacle, or the detected travel state, and calculates a target steering angle corresponding to the target travel line. The autonomous driving ECU 70 transmits the calculated target steering angle to the EPS 40, causing the EPS 40 to perform the automatic steering control based on the target steering angle. Thus, the actual steering angle of the vehicle 10 changes according to the target steering angle; accordingly, the vehicle 10 automatically travels along the target travel line. In addition, the autonomous driving ECU 70 automatically controls the engine 21, the transmission, and the like according to the control of the EPS 40, causing an automatic change in the travel speed, speed level, etc., of the vehicle 10.

Furthermore, the autonomous driving ECU 70 determines, on the basis of the position of the preceding vehicle or the obstacle, whether there is a probability of collision between the vehicle 10 and the preceding vehicle or the obstacle, and when there is a probability of a collision, causes the electronic control brake system 30 to perform the automatic brake control. This allows the vehicle 10 to avoid collisions even during the autonomous driving control.

Furthermore, on the basis of the vehicle state that can be acquired from the ECUs 20, 30, 40, 50, 60, the autonomous driving ECU 70 monitors the vehicle 10 for any abnormality. An abnormality in the vehicle 10 is, for example, an abnormality in the output of the travel information sensor 73. Since continuing the autonomous driving control becomes difficult if an abnormality occurs in the output of the travel information sensor 73, the autonomous driving ECU 70 detects this situation as an abnormality in the vehicle.

When detecting an abnormality in the vehicle 10, the autonomous driving ECU 70 performs a safety securement control for securing the safety of the vehicle 10. As the safety securement control, first, the autonomous driving ECU 70 performs an authority transfer control in which the authority of driving the vehicle 10 is transferred from the autonomous driving ECU 70 to an occupant. In the authority transfer control, an authority transfer announcement to the effect that the authority of driving the vehicle 10 is to be transferred from the autonomous driving ECU 70 to an occupant is made by turning on a warning light or the like of the vehicle or using sound from a loudspeaker of the vehicle 10. When the occupant performs a predetermined operation on the input device 72 according to this authority transfer announcement, the autonomous driving ECU 70 detects the operation. On the basis of detection of the predetermined operation, the autonomous driving ECU 70 determines that the occupant is ready to start a manual operation of the vehicle 10, and switches the drive mode of the vehicle 10 from the autonomous drive mode to the manual drive mode. Thus, the manual operation of the vehicle 10 by the occupant is made available. Hereinafter, the authority transfer control will be referred to simply as “TOR”, which stands for take over request.

On the other hand, when the predetermined operation is not performed on the input device 22 in the period until the lapse of a predetermined length of time after a point in time when the authority transfer announcement is made, the autonomous driving ECU 70 determines that the occupant is not ready to perform the manual operation of the vehicle 10. In this case, the autonomous driving ECU 70 performs an evacuation travel control. Specifically, the autonomous driving ECU 70 continues the autonomous driving control, causes the vehicle 10 to decelerate and autonomously travel to a road shoulder or the like, and at a point in time when the vehicle 10 reaches the road shoulder, causes the vehicle 10 to stop. Hereinafter, the evacuation travel control will be referred to simply as “MRM”, which stands for minimum risk maneuver.

The autonomous driving ECU 70 can perform the MRM directly without making the authority transfer announcement as the safety securement control.

The vehicle 10 further includes a data storage device 90. When an abnormality occurs in the vehicle 10, various status quantities of the vehicle 10 upon the occurrence of the abnormality are stored into the data storage device 90. Thus, the cause of the abnormality can be investigated by analyzing information stored in the data storage device 90.

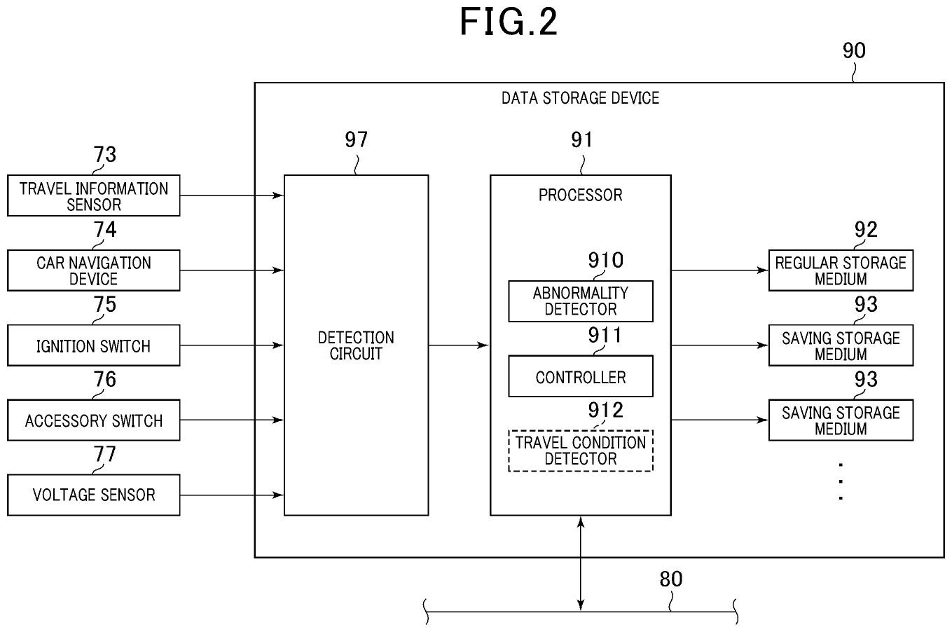

As shown in FIG. 2, the data storage device 90 receives output signals of the travel information sensor 73, various switches 74 of the vehicle 10, an ignition switch 75, an accessory switch 76, a voltage sensor 77, and the like. The voltage sensor 77 detects the voltage applied between terminals of a battery mounted on the vehicle and outputs a signal corresponding to the detected voltage.

The data storage device 90 includes a processor 91, a regular storage medium 92, one or more saving storage media 93, and a detection circuit 97.

The detection circuit 97 receives the output signals of the travel information sensor 73, the switch 74, the ignition switch 75, the accessory switch 76, the voltage sensor 77, and the like, and transmits the received signals to the processor 91.

The processor 91 includes a CPU and the like. The processor 91 includes an abnormality detector 910 and a controller 911.

The abnormality detector 910 detects an abnormal state on the basis of the information acquired from each of the ECUs 20, 30, 40, 50, 60, 70 via the in-vehicle network 80. Specifically, the ECUs 20 to 70 individually monitor corresponding control systems for any abnormality. In response to a request from the abnormality detector 910, each of the ECUs 20 to 70 reports the abnormality detection result of the control system on each occasion to the abnormality detector 910. The abnormality detector 910 detects an abnormal state on the basis of the abnormality detection result transmitted from each of the ECUs 20 to 70, the output values of the sensors 73, 77 and the switches 74 to 76, and so on. An abnormal state detected by the abnormality detector 910 includes, for example, an abnormality in the vehicle 10, an abnormality in an occupant, and an abnormality in the environment surrounding the vehicle 10.

An occupant abnormality indicates, for example, the case where the driver is asleep while the vehicle travels without problems. The abnormality in the vehicle 10 includes, for example, an abnormality in an in-vehicle device or an in-vehicle system that is controlled according to the autonomous driving control, an abnormality in the behavior of the vehicle 10, and an abnormality in a redundant system of the in-vehicle device or the in-vehicle system. The abnormality in the behavior of the vehicle 10 indicates, for example, the case where the vehicle 10 weaves, which is different from how the vehicle 10 normally travels, or the case where the vehicle 10 is rapidly accelerated regardless of whether the vehicle 10 is failed. In other words, the abnormality detector 910 detects, as an abnormal state, not only the case where an abnormality actually occurs in the vehicle 10, but also the situation in which the vehicle 10 seems to have no problem in traveling although a part of the devices of the vehicle may be failed, such as the case where the vehicle weaves, which is different from how the vehicle normally travels. In addition, the abnormality detector 910 detects, as an abnormal state, the state where the vehicle 10 seems to cause a problem in the feature, such as the case where the vehicle is rapidly accelerated regardless of whether the vehicle is failed.

Specifically, the abnormality detector 910 detects an abnormality in an occupant on the basis of the state of the occupant detected by the in-vehicle ECU 60 using the occupant monitor sensor 62. For example, when the authority (responsibility) of driving cannot be transferred to an occupant, the abnormality detector 910 determines that the occupant is abnormal. When the following conditions (a1) to (a5) are met, for example, the abnormal detector 910 determines that the authority of driving cannot be transferred to an occupant.

(a1) The case where an odor sensor or the like included in the occupant monitor sensor 62 detects consumption of alcohol by an occupant.

(a2) The case where a camera or the like included in the occupant monitor sensor 62 detects that an occupant is unconscious. The situation in which an occupant is unconscious specifically means a situation in which the occupant is asleep, a situation in which the occupant is drowsy, a situation in which the occupant is blacked out, or a situation in which the occupant is dead.

(a3) The case where a seating sensor or the like included in the occupant monitor sensor 62 detects that no occupant is seated in the driver seat.

(a4) The case where an attachment/detachment sensor included in the occupant monitor sensor 62 detects that an occupant does not wear a safety device such as a seatbelt.

Furthermore, when the following conditions (b1) to (b9) are met, for example, the abnormal detector 910 detects an abnormality in the in-vehicle device or the in-vehicle system.

(b1) An abnormality in the recognition function. This abnormality includes an abnormality in the camera, the lidar device, or the like included in the surrounding recognition sensor 71. Furthermore, this abnormality includes an abnormality in a sensor necessary for the control of a wiper device, a lighting device, or the like. When an abnormality occurs in the wiper device, a wiper may stop and block the range of the surrounding recognition sensor 71, and thus this is also detected as an abnormality in the recognition function.

(b2) An abnormality in the determination function. This abnormality includes an abnormality in each of the ECUs 20 to 70.

(b3) An abnormality in the operation function. This abnormality includes an abnormality in an actuator, a pump, or the like in the engine system, the ECU 30, and the EPS 40.

(b4) An abnormality in the power supply system. This abnormality includes disconnection, short-circuiting, and an abnormality in a DDC, the voltage, the electric current, the IG switch, the Ready switch, or the like.

(b5) An abnormality in the fuel system. This abnormality includes a fuel shortage, fuel leakage, and the like.

(b6) An abnormality in the safety system. This abnormality includes an abnormality in the airbag device and an abnormality in the seatbelt device including a pretensioner.

(b7) An abnormality in the driver assistance system. The driver assistance system is, in particular, a safety-related assistance system as a prerequisite for autonomous driving. This abnormality includes an abnormality in an ABS, a VSC, a collision reducing brake, or the like.

(b8) An abnormality in the occupant instruction system. This abnormality includes an abnormality in the car navigation device, a sensor of the brake pedal, a sensor of the accelerator pedal, a sensor of the steering, or the like.

(b9) An abnormality in the status indication system. This abnormality includes an abnormality in the car navigation device, an instrument panel, a shift indication, a fuel indication, or the like.

Furthermore, when the following conditions (c1) and (c2) are met, for example, the abnormal detector 910 detects an abnormality in the surrounding environment.

(c1) The case such as subsidence, snow, and torrential rain (squall) where autonomous driving is inadequate.

(c2) The case where the autonomous driving ECU 70 cannot recognize an obstacle or the like due to other environmental causes. For example, the case beyond the recognition limit in the autonomous driving ECU 70.

Furthermore, the abnormality detector 910 detects an abnormal state on the basis of the occurrence of unintended lateral acceleration, rapid acceleration, or rapid deceleration of the vehicle 10 due to an external environmental factor. Examples of the external environmental factor include contact with another vehicle, vibration due to an earthquake, etc., and a sudden fall due to subsidence, etc. For example, when the deviation between the actual acceleration of the vehicle 10 and the target acceleration of the vehicle 10 that is set according to the autonomous driving control becomes greater than or equal to a predetermined value, the abnormality detector 910 detects an abnormal state based on an external environmental factor.

The controller 911 causes the regular storage medium 92 to regularly store the output value of each of the sensors 73, 77 and the switches 74 to 76 and the information acquired from each of the ECUs 20 to 70. Furthermore, when the abnormality detector 910 detects an abnormal state, the controller 911 copies data stored in the regular storage medium 92 to each of one or more saving storage media 93. The regular storage medium 92 includes, for example, a non-volatile or volatile storage medium. The saving storage medium 93 includes a non-volatile storage medium.

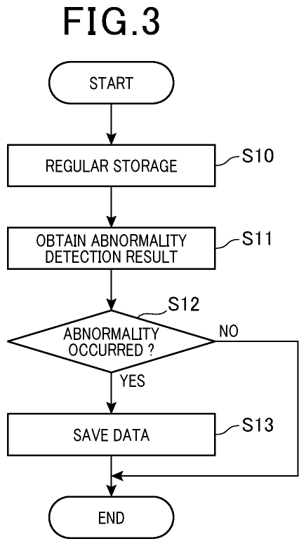

Next, with reference to FIG. 3, the specific flow of a process that is performed by the controller 911 will be described. The controller 911 repeatedly performs the processes shown in FIG. 3 in a predetermined cycle.

As shown in FIG. 3, first, in the process in step S10, the controller 911 causes the regular storage medium 92 to store the output value of each of the sensors 73, 77 and the switches 74 to 76 and the information acquired from each of the ECUs 20 to 70.

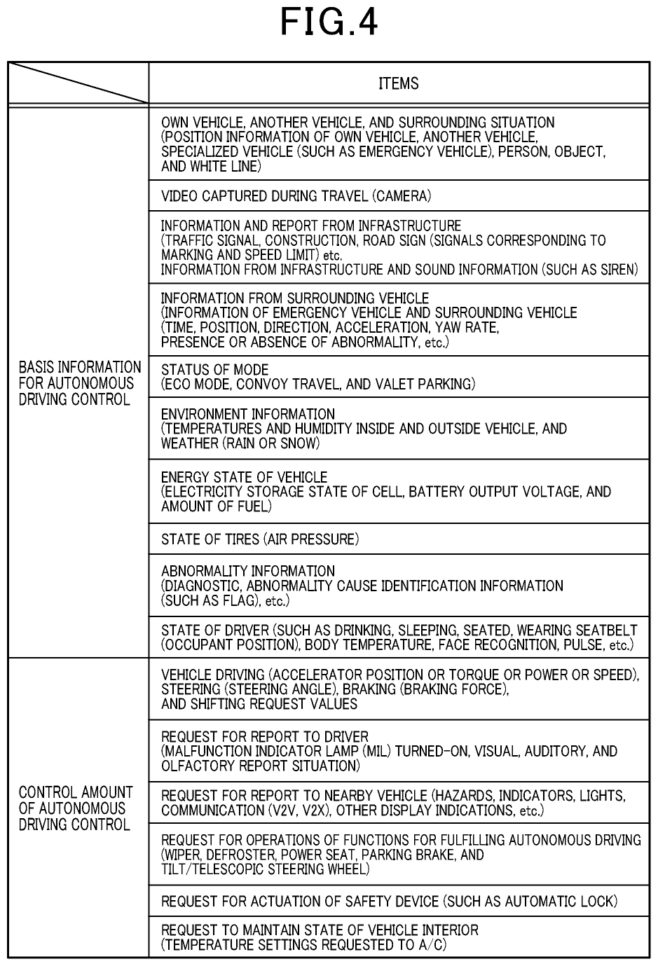

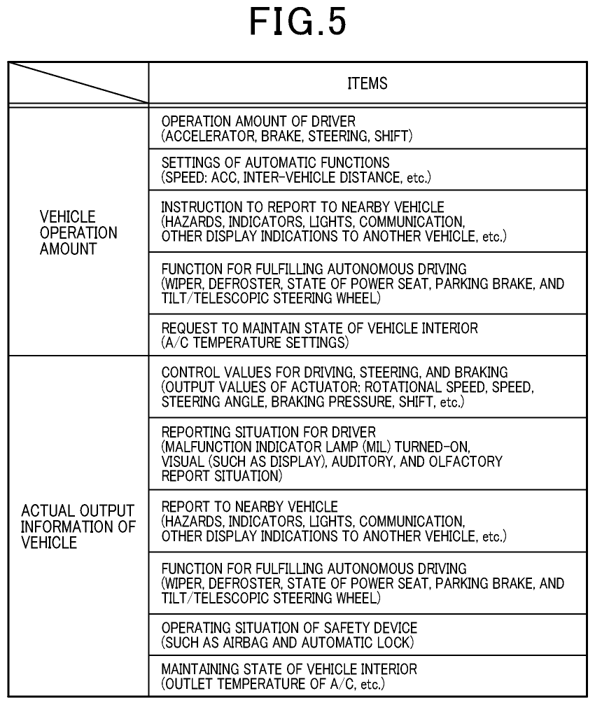

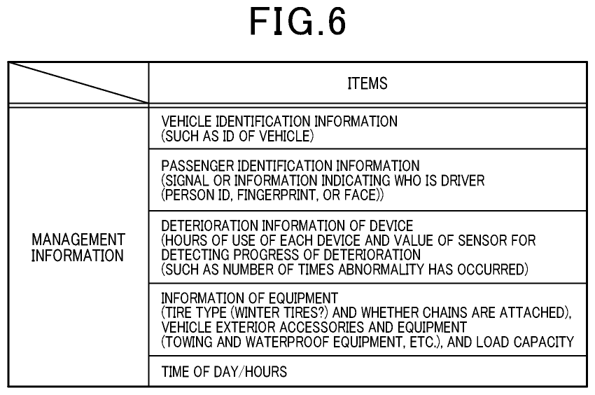

The information acquired by the controller 911 from each of the ECUs 20 to 70 can be roughly classified as information related to autonomous driving shown in FIG. 4, information related to manual driving shown in FIG. 5, and management information shown in FIG. 6. As shown in FIG. 4, the autonomous driving-related information includes “basis information for autonomous driving control” and a “control amount of autonomous driving control”. The “control amount of autonomous driving control” includes, for example, a control amount transmitted from the autonomous driving ECU 70 to each of the ECUs 20 to 60. The “basis information for autonomous driving control” includes information providing grounds for the control amount transmitted from the autonomous driving ECU 70 to each of the ECUs 20 to 60. In the “basis information for autonomous driving control”, not only the state of the vehicle, but also the state of a person are recorded. As shown in FIG. 5, the manual driving-related information includes a “vehicle operation amount” and “actual output information of the vehicle 10”. The “vehicle operation amount” is input information from an occupant to the vehicle and is equivalent to the amount of operations performed by the occupant on the vehicle. Specific details of the information related to automatic diving, the information related to manual driving, and the management information are as shown in columns “ITEMS” in FIGS. 4 to 6.

The information and signals indicated in each item need not be information and signals and may be sensor values, information, signals, and the like required to calculate said information and signals.

The controller 911 causes the regular storage medium 92 to store at least one piece of information that can be used to analyze whether the subject driving the vehicle is the autonomous driving ECU 70, among the items corresponding to the information related to autonomous driving, the information related to manual driving, and the management information shown in FIGS. 4 to 6. In the present embodiment, the information indicated in the items shown in FIGS. 4 to 6 and the output values of the sensors 73, 77 and the switches 74 to 76 are equivalent to the determination information allowing for determination of whether the subject driving the vehicle 10 at the time of detection of an abnormal state by the abnormality detector 910 is the autonomous driving ECU 70.

The controller 911 acquires at least the following information (α), more preferably acquires the following information (β), and more preferably acquire the following information (γ).

(α) Information that can be used to analyze whether the subject driving the vehicle is the autonomous driving ECU 70.

(β) Information that can be used to analyze the adequacy of the process performed by the autonomous driving ECU 70.

(γ) Information that can be used to analyze whether a vehicle, a person, or the like that triggers various controls during autonomous driving is normal or abnormal.

The controller 911 causes the regular storage medium 92 to store at least one of the following (α1) and (α2) as the above information (α).

(α1) “A value of a flag or the like indicating whether autonomous driving is ON”. In the present embodiment, this flag is equivalent to the information directly indicating whether autonomous driving is ON.

(α2) “Input information of driving, steering, braking, and shifting request values from the autonomous driving function to the vehicle” and “input information of driving, steering, braking, and gear shifting by an occupant”.

Furthermore, the controller 911 causes the regular storage medium 92 to store at least one of the following (β1) to (β3) as the above information (β).

(β1) “Input information of driving, steering, braking, and shifting request values from the autonomous driving function to the vehicle” as the control amount of autonomous driving control.

(β2) An “own vehicle, another vehicle, and the surrounding situation” as the basis information for autonomous driving control.

(β3) “Driving, steering, braking, and shifting control values” as the actual output information of the vehicle.

Furthermore, the controller 911 causes the regular storage medium 92 to store at least the following (γ1) as the above information (γ).

(γ1) “Abnormality information” and the “state of a driver” as the information that can be used to analyze an event that triggers various controls during autonomous driving.

As the information stored in the regular storage medium 92, there are three combinations of information, (α) only, “(α)+(β)”, and “(α)+(β)+(γ)”.

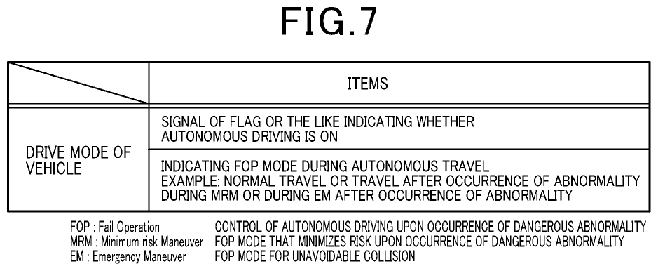

As shown in FIG. 3, after the control unit 911 performs the process in step S10, the abnormality detector 910 acquires the abnormality detection result from each of the ECUs 20 to 70 as a process in step S11, and causes the regular storage medium 92 to store information corresponding to the acquired abnormality detection result. Furthermore, the abnormality detector 910 causes the regular storage medium 92 to store at least one piece of the information indicated in the items corresponding to information of the drive mode of the vehicle 10 shown in FIG. 7. In the present embodiment, this information of the drive mode of the vehicle 10 is also included in the determination information.

Regarding “whether there is an abnormality & whether the MRM is ON” in the information of the drive mode of the vehicle 10 in FIG. 7, whether the MRM is ON may be determined according to time elapsed after the occurrence of an abnormality; thus, the flag indicating whether the MRM is ON may be replaced by time elapsed after the occurrence of an abnormality. Furthermore, since transition to the MRM occurs after the occurrence of an abnormality, if time between the occurrence of an abnormality and transition to the MRM is fixed, only whether there is an abnormality may be enough.

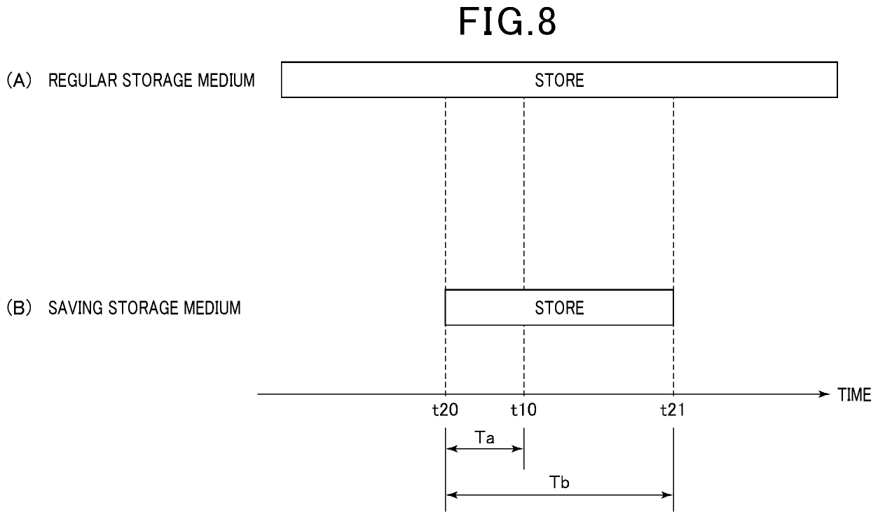

As shown in FIG. 3, subsequently to the process in step S11, the controller 911 determines, on the basis of the abnormality detection result acquired from each of the ECUs 20 to 70, whether the vehicle 10 has an abnormality, as a process in step S12. When an affirmative determination is made in the process in step S12, that is, when the vehicle 10 has an abnormality, when the controller 911 copies the data stored in the regular storage medium 92 to each of the one or more saving storage media 93 as a process in step S13. Specifically, as shown in (A) and (B) in FIG. 8, the controller 911 sets time t20, which is a predetermined length of time Ta before time t10 at which the abnormality is detected, as reference time, and copies the data stored in the regular storage medium 92 in the period between the reference time t20 and time 21, which is a predetermined length of time Tb after the reference time t20, to each of the one or more saving storage media 93.

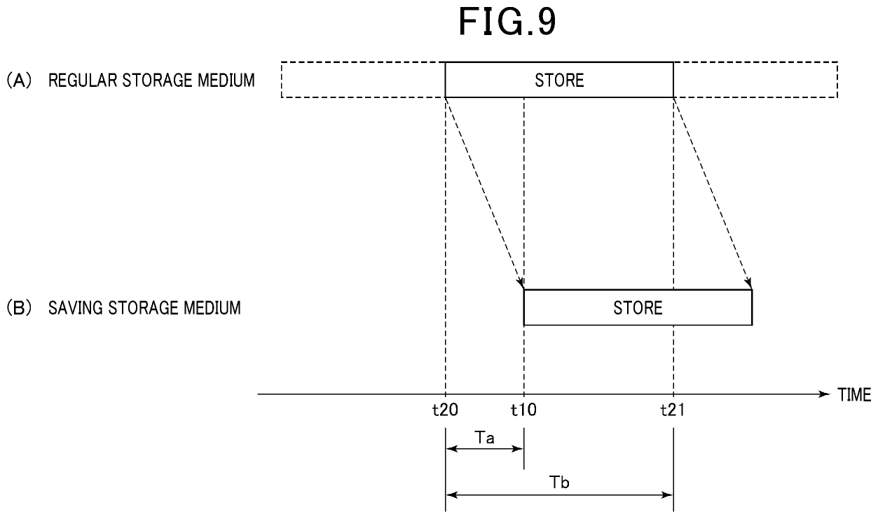

As shown in (A) and (B) in FIG. 9, the controller 911 may perform, in parallel, the process of causing the regular storage medium 92 to store various kinds of information and the process of copying the data stored in the regular storage medium 92 to the one or more saving storage media 93 after time t10 at which the abnormality is detected.

As shown in FIG. 3, when step S13 is performed, the controller 911 brings a series of processes to an end. Also when a negative determination is made in the process in step S12, that is, when the vehicle 10 has no abnormality, the controller 911 brings a series of processes to an end.

With the data storage device 90 according to the present embodiment described above, the effects indicated in (1) and (2) below can be acquired.

(1) When any abnormality occurs in the vehicle 10, the determination information such as those shown in FIGS. 4 to 7 is stored into the saving storage media 93. Therefore, whether the subject driving the vehicle upon the occurrence of the abnormality is a person or the autonomous driving ECU 70 can be analyzed by analyzing the determination information stored in the saving storage media 93.

(2) The controller 911 causes the saving storage medium 93 to store the determination information in the period until the lapse of the predetermined length of time Tb after the reference time t20, which is set on the basis of time t10 at which the abnormality detector 910 detects an abnormal state. Thus, whether the subject driving the vehicle in the period until the lapse of the predetermined length of time Tb after the reference time t20 is a person or the autonomous driving ECU 70 can be easily analyzed by analyzing the determination information stored in the saving storage media 93.

### (First Variation)

Next, the first variation of the data storage device 90 according to the first embodiment will be described. Hereinafter, various data stored in the regular storage medium 92 according to the first embodiment will be referred to as “regular storage data”, and various data stored in the saving storage media 93 according to the first embodiment will be referred to as “saving storage data” for the sake of convenience.

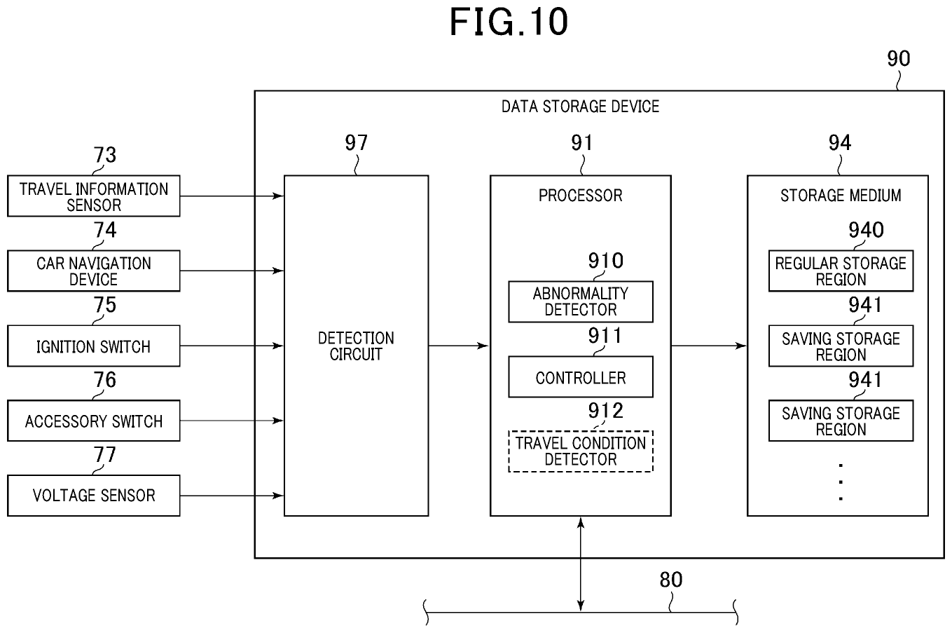

As shown in FIG. 10, the data storage device 90 according to the present variation includes one storage medium 94 instead of the regular storage medium 92 and the saving storage media 93. The storage medium 94 includes a non-volatile storage medium. In the storage medium 94, a regular storage region 940 and one or more saving storage regions 941 are provided. The controller 911 causes the regular storage region 940 to store the regular storage data and causes the saving storage region 941 to store the saving storage data.

### (Second Variation)

Next, the second variation of the data storage device 90 according to the first embodiment will be described.

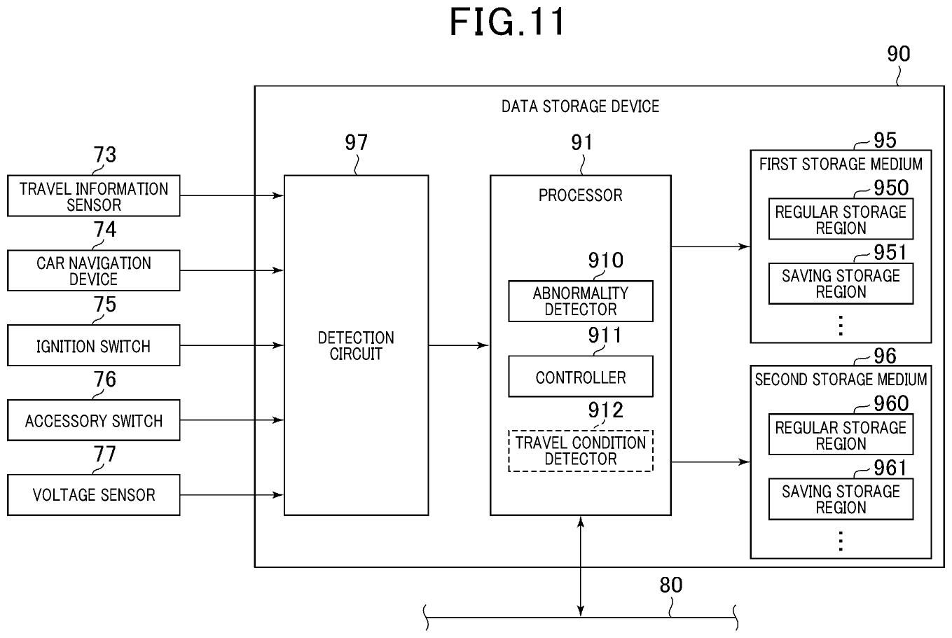

As shown in FIG. 11, the data storage device 90 according to the present variation includes a first storage medium 95 and a second storage medium 96 instead of the regular storage medium 92 and the saving storage media 93. Each of the first storage medium 95 and the second storage medium 96 includes a non-volatile storage medium.

In the first storage medium 95, a regular storage region 950 and one or more saving storage regions 951 are provided. When the abnormality detector 910 detects an abnormal state, the controller 911 causes the regular storage region 960 in the first storage medium 95 to store the regular storage data, and causes the one or more saving storage regions 961 in the first storage medium 95 to store the saving storage data.

In the second storage medium 96, a regular storage region 960 and one or more saving storage regions 961 are provided. When the drive mode of the vehicle 10 is switched from the manual drive mode to the autonomous drive mode, the controller 911 causes the regular storage region 960 in the second storage medium 96 to store the regular storage data, and causes the one or more saving storage regions 961 in the second storage medium 96 to store the saving storage data.

### (Third Variation)

Next, the third variation of the data storage device 90 according to the first embodiment will be described.

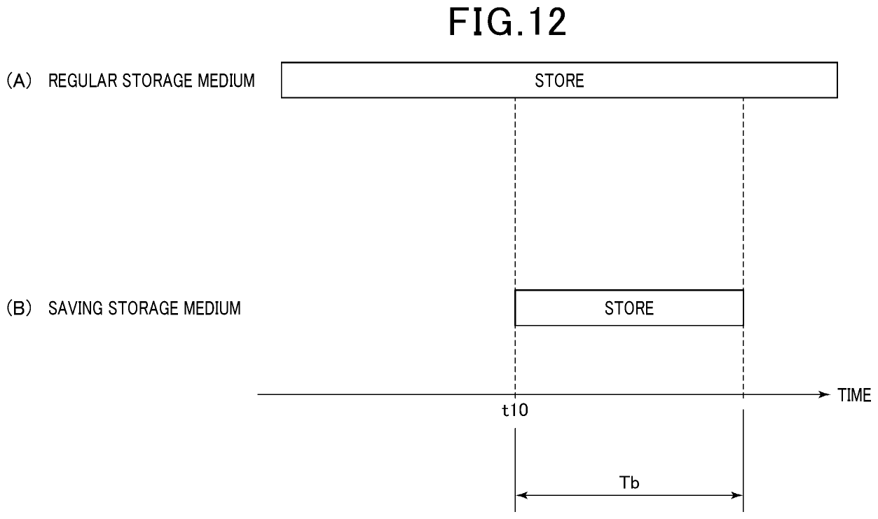

As shown in (A) and (B) in FIG. 12, the controller 911 according to the present variation sets, as reference time, time t10 at which the abnormality detector 910 detects an abnormal state, and causes the saving storage medium 93 to store the saving storage data in the period until the lapse of the predetermined length of time Tb after that reference time t10.

### (Fourth Variation)

Next, the fourth variation of the data storage device 90 according to the first embodiment will be described.

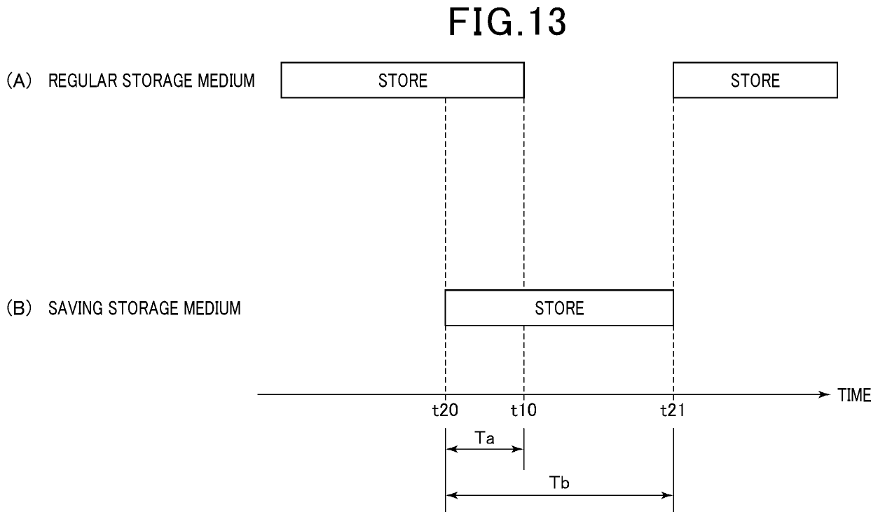

As shown in (A) and (B) in FIG. 13, when the abnormality detector 910 detects an abnormal state at time t10, the controller 911 according to the present variation causes the one or more saving storage media 93 to store the data stored in the regular storage medium 92 in the period until time t20, which is the predetermined length of time Ta before time t10. At time t10 and onward, the controller 911 suspends data storage into the regular storage medium 92 and causes the saving storage media 93 to store data such as the determination information. At time t21 and onward, the controller 911 suspends data storage into the saving storage media 93 and resumes data storage into the regular storage medium 92.

With such a configuration, electric power that is consumed to copy data from the regular storage medium 92 to the saving storage media 93 can be reduced.

### (Fifth Variation)

Next, the fifth variation of the data storage device 90 according to the first embodiment will be described.

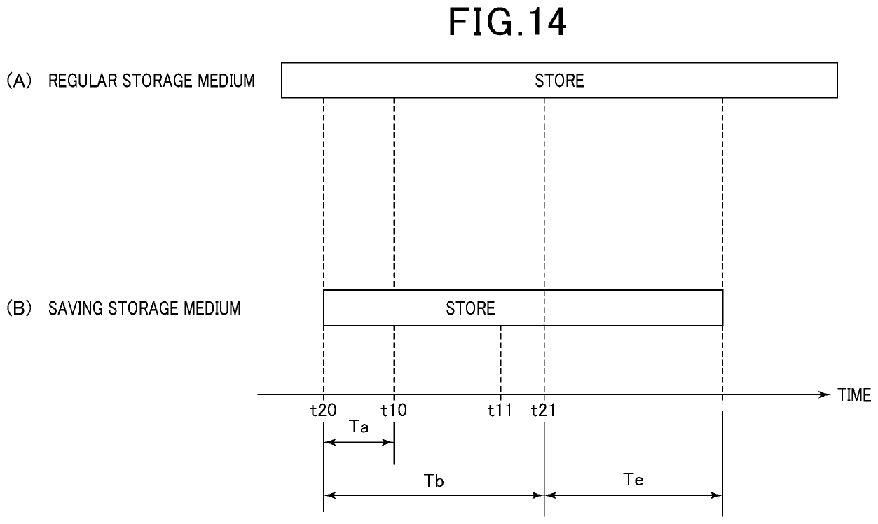

As shown in (A) and (B) in FIG. 14, when the abnormality detector 910 detects an abnormal state at time t10, the controller 911 according to the present variation causes the saving storage media 93 to store the saving storage data together with a first abnormality occurrence flag. Furthermore, when the abnormality detector 910 further detects an abnormal state at time t11 in the period until time t21, which is the predetermined length of time Tb after the reference time t20, the controller 911 causes a second abnormality occurrence flag to be stored in the saving storage data, and extends, by a predetermined length of time Te, a period in which the saving storage data is stored into the one or more saving storage media 93.

With such a configuration, even when multiple abnormalities occur, whether the subject driving the vehicle upon the occurrence of the abnormalities is a person or the autonomous driving ECU 70 can be analyzed by analyzing the determination information stored in the saving storage media 93. Furthermore, the relationship between the abnormalities and the data stored in the saving storage media 93 can be easily determined on the basis of the abnormality occurrence flag.

The controller 911 may change the predetermined length of time Tb and the extension time Te not only upon entry into an abnormal state, but also upon the occurrence of a predetermined trigger. The predetermined trigger is, for example, at least one of those listed in (d1) to (d6) below.

(d1) Transition to the autonomous drive mode. For example, the case where a driver provides an instruction about transition to the autonomous drive mode after an abnormality occurs in the vehicle 10.

(d2) Occurrence of an abnormality that impedes autonomous driving. For example, the case where an abnormality occurs in a device or recognition is made impossible due to snow or the like.

(d3) Inability of the autonomous driving ECU 70 to recognize an obstacle or the like. For example, the case beyond the recognition limit of the autonomous driving ECU 70.

(d4) Detection of an abnormal value of lateral acceleration of the vehicle 10, unintended rapid acceleration or rapid deceleration of the vehicle 10, or the like.

(d5) Transfer of the authority of driving to an occupant.

(d6) Occurrence of an abnormality in a driver. For example, the case where the driver is unconscious, drunk, or does not wear the seatbelt.

Furthermore, the controller 911 may cause the saving storage medium 93 to store the trigger information.

### (Sixth Variation)

Next, the sixth variation of the data storage device 90 according to the first embodiment will be described.

In the present variations, a plurality of saving storage media 93 are provided.

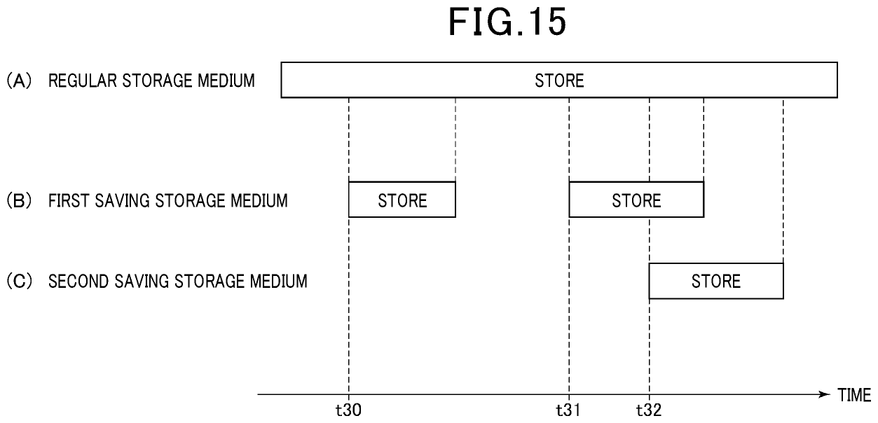

As shown in (A) to (C) in FIG. 15, when the abnormality detector 910 detects an abnormal state at time t30, the controller 911 according to the present variation causes a first saving storage medium among the plurality of saving storage media 93 to store the saving storage data. Furthermore, when the same abnormality is detected at time t31 after time t30, the controller 911 causes the first saving storage medium to store the saving storage data.

Furthermore, when another abnormality is detected at time t32 after time t31, the controller 911 causes a second saving storage medium, which is different from the first saving storage medium, to store the saving storage data. In this manner, the controller 911 according to the present variation switches the saving storage medium according to the type of an abnormality. Instead of the method for switching the saving storage medium, a method for switching the storage region in the storage medium may be used.

### (Seventh Variation)

Next, the seventh variation of the data storage device 90 according to the first embodiment will be described.

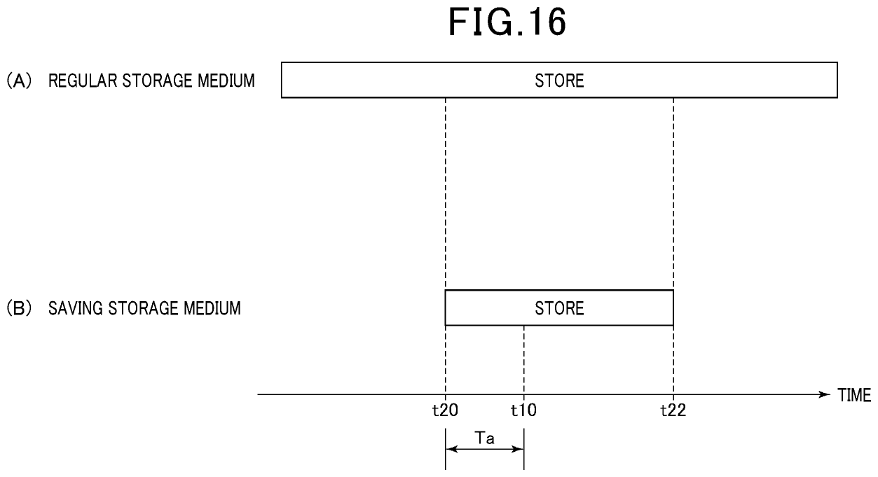

As shown in (A) and (B) in FIG. 16, the controller 911 according to the present variation copies the data stored in the regular storage medium 92 to each of the one or more saving storage media 93 in the period between the reference time t20 and time t22, at which the drive mode switches from the autonomous drive mode to the manual drive mode. Time t22 corresponds to time at which the authority of driving the vehicle 10 is transferred from the autonomous driving ECU 70 to an occupant. Furthermore, the controller 911 suspends data copying to the saving storage media 93 at time t22 and onward. In other words, in the case where an occupant has the authority of driving, even when an abnormality occurs in the autonomous driving system including the autonomous driving ECU 70 and the like, the abnormality is not stored into the saving storage media 93.

Time t22 is not limited to time at which the authority of driving the vehicle 10 is transferred from the autonomous driving ECU 70 to an occupant. For example, time at which the operation to stop the vehicle 10 is performed after transfer of the authority of driving to an occupant may be set as time t22. Alternatively, time at which an abnormal state is corrected may be set as time t22.

With such a configuration, data such as the determination information is stored in the saving storage media 93 only in the period for which the drive mode of the vehicle 10 is the autonomous drive mode, and thus an excessive increase in the data usage of the saving storage media 93 can be avoided.

### (Eighth Variation)

Next, the eighth variation of the data storage device 90 according to the first embodiment will be described.

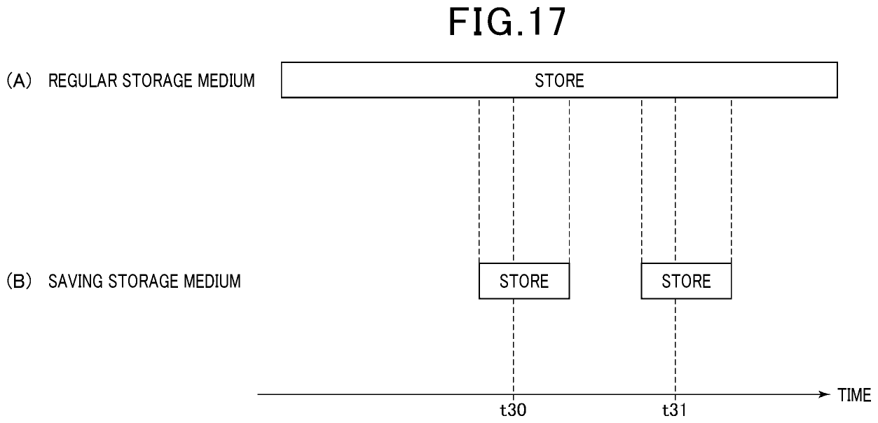

As shown in (A) and (B) in FIG. 17, when the abnormality detector 910 detects an abnormal state at time t30, the controller 911 according to the present variation copies the data stored in the regular storage medium 92 to each of the one or more saving storage media 93 in the periods before and after time t30. Furthermore, when the drive mode of the vehicle 10 switches from the autonomous drive mode to the manual drive mode at time t31, the controller 911 copies the data stored in the regular storage medium 92 to each of the one or more saving storage media 93 in the periods before and after time t23.

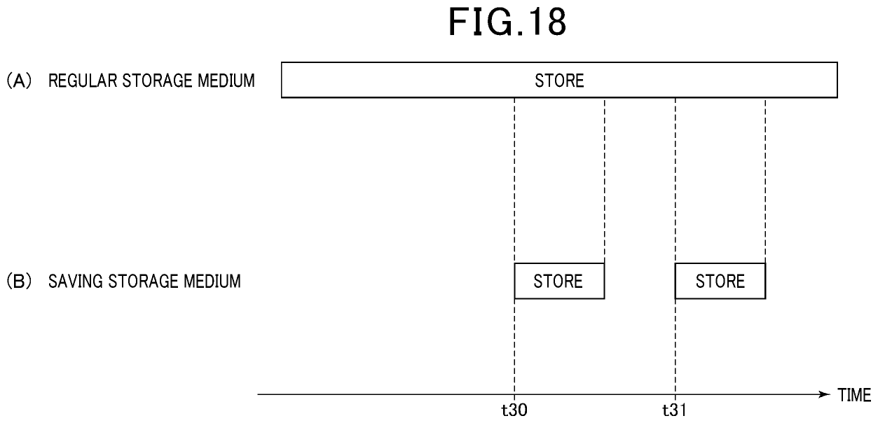

As shown in FIG. 18, the controller 911 may copy the data stored in the regular storage medium 92 to each of the one or more saving storage media 93 in the period until the lapse of a predetermined length of time after time t30. Furthermore, the controller 911 may copy the data stored in the regular storage medium 92 to each of the one or more saving storage media 93 in the period until the lapse of a predetermined length of time after time t31.

### (Ninth Variation)

Next, the ninth variation of the data storage device 90 according to the first embodiment will be described.

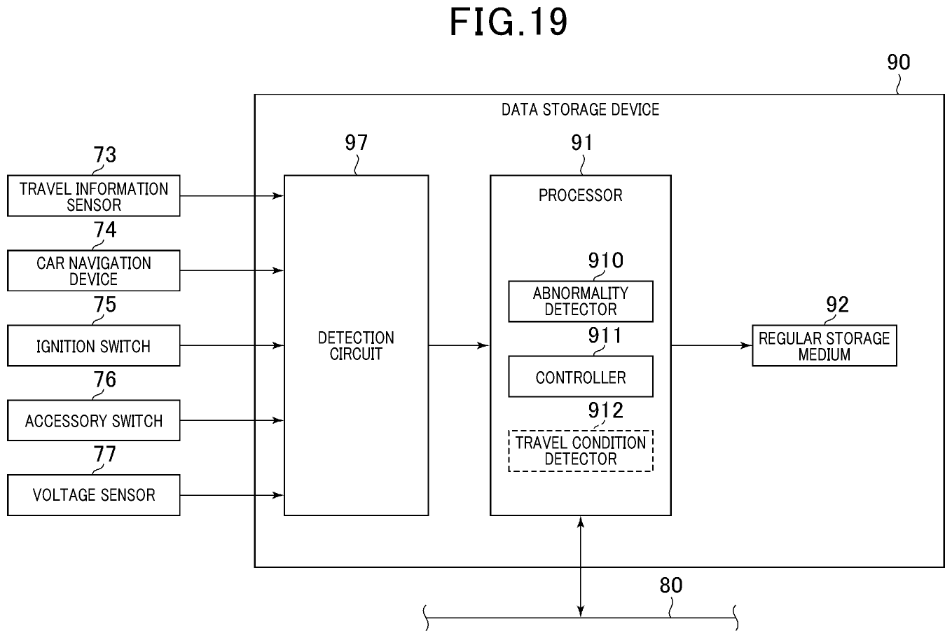

As shown in FIG. 19, the data storage device 90 according to the present variation includes the regular storage medium 92 only. The controller 911 causes the regular storage medium 92 to store one-trip determination information. One trip represents the period between the point in time of the start of travel of the vehicle 10 and the end of the travel of the vehicle 10.

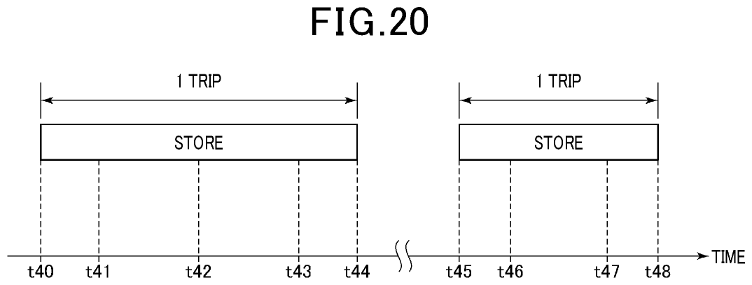

Specifically, as illustrated in FIG. 20, the controller 911 according to the present variation causes the regular storage medium 92 to store data such as the determination information in the period between time t40 and time t44 that corresponds to one trip. Time t40 represents time at which travel of the vehicle 10 starts. And time t44 represents time at which the travel of the vehicle 10 ends. Thus, when abnormalities occur in the vehicle 10 at time t42, t43 after the drive mode of the vehicle 10 is switched to the autonomous drive mode at time t41, data such as the determination information at said points in time is stored into the regular storage medium 92. Therefore, whether the subject driving the vehicle upon the occurrence of the abnormalities is a person or the autonomous driving ECU 70 can be analyzed by analyzing the data stored in the regular storage medium 92.

Furthermore, assume that travel of the vehicle 10 starts at time t45 after the vehicle stops at time t44 due to the occurrence of an abnormality. Even in this case, the controller 911 causes the regular storage medium 92 to store data such as the determination information in the period between time t45 and time t48, which is the end of one trip. Therefore, even when the authority of driving the vehicle 10 is transferred to an occupant at time t47 after the drive mode of the vehicle 10 is transferred to the autonomous drive mode at time t46, data such as the determination information at said points in time is stored in the regular storage medium 92. Thus, even when an abnormality occurs in the vehicle 10, whether the subject driving the vehicle upon the occurrence of the abnormality is a person or the autonomous driving ECU 70 can be analyzed by analyzing the data stored in the regular storage medium 92.

When the data usage of the regular storage medium 92 reaches the upper limit of storage capacity, the controller 911 deletes the data in chronological order.

### (Tenth Variation)

Next, the tenth variation of the data storage device 90 according to the first embodiment will be described.

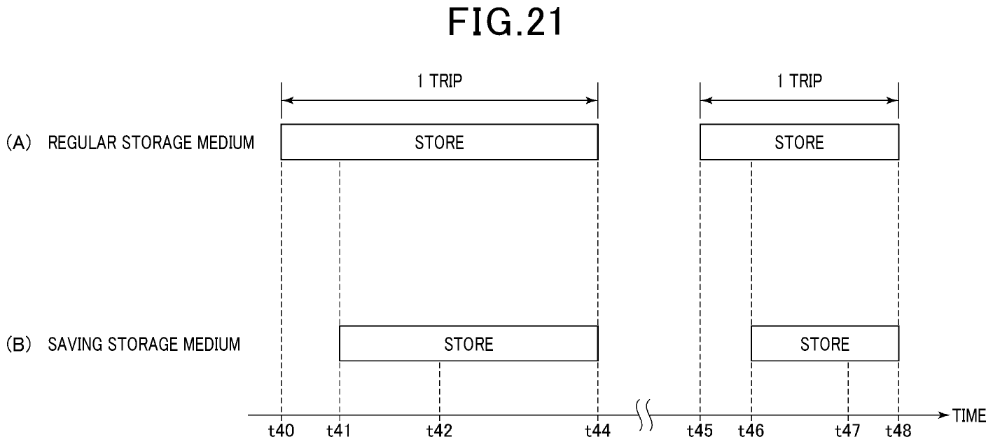

As shown in (A) and (B) in FIG. 21, the controller 911 according to the present variation causes the regular storage medium 92 to store the determination information in the period between time t40 and time t44 that corresponds to one trip and the period between time t45 and time t48 that corresponds to one trip. Furthermore, when the drive mode of the vehicle 10 is switched to the autonomous drive mode at time t41, t46, etc., the controller 911 copies the data stored in the regular storage medium 92 at said time and onward to the saving storage medium 93.

### (Eleventh Variation)

Next, the eleventh variation of the data storage device 90 according to the first embodiment will be described.

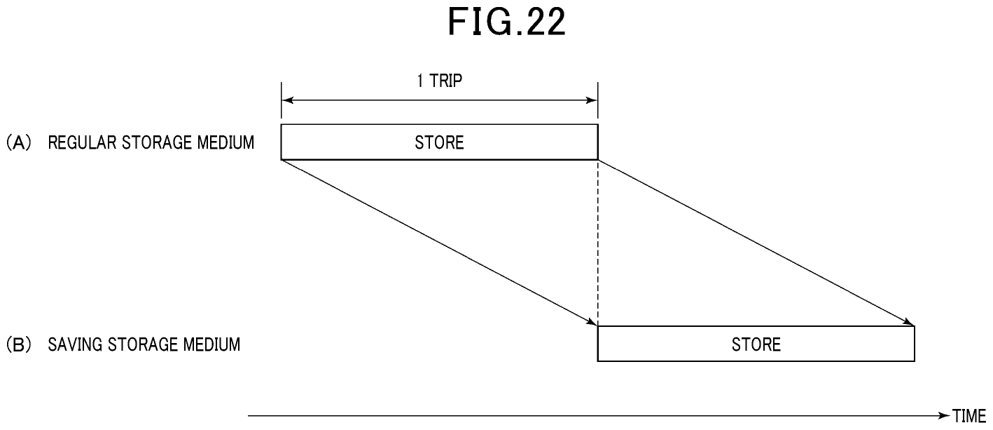

As shown in (A) and (B) in FIG. 22, the controller 911 causes the saving storage medium 93 to store one-trip data stored in the regular storage medium 92 after the end of one trip or during the next trip and onward, for example. After the end of several trips, when the vehicle 10 arrives at a specific location such as a workplace and home, the controller 911 may cause the saving storage medium 93 to store the data stored in the regular storage medium 92.

### (Twelfth Variation)

Next, the twelfth variation of the data storage device 90 according to the first embodiment will be described.

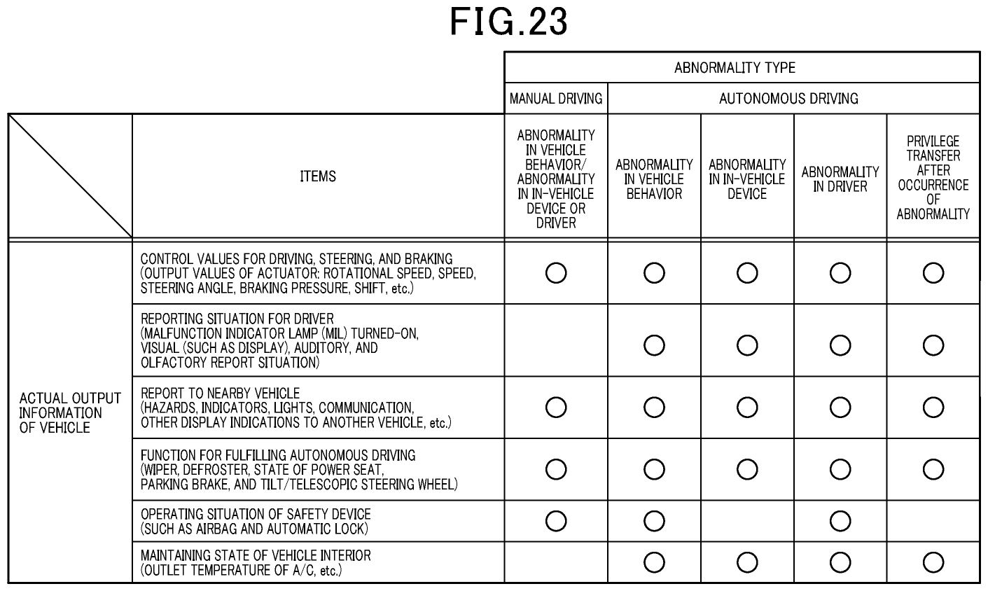

As shown in FIG. 23, the controller 911 according to the present variation changes, according to the type of the abnormality detected by the abnormality detector 910, data to be stored into the regular storage medium 92 and the saving storage medium 93. The data indicated by circles in FIG. 23 represents data that may be selected as data to be stored into the regular storage medium 92 and the saving storage medium 93. The data not indicated by circles represents data that is not stored into the regular storage medium 92 or the saving storage medium 93. Although FIG. 23 exemplifies only data related to the “actual output information of the vehicle 10”, data to be selected is set according to the abnormality type similarly for the information related to autonomous driving shown in FIG. 4, the information related to manual driving shown in FIG. 5, and the management information shown in FIG. 6. The controller 911 causes the regular storage medium 92 and the saving storage medium 93 to store at least one piece of data associated with the type of the abnormality detected by the abnormality detector 910.

During data storage into the regular storage medium 92 and the saving storage medium 93 triggered by the occurrence of an abnormality, when another abnormality occurs, the controller 911 causes the regular storage medium 92 and the saving storage medium 93 to store data corresponding to the logical sum of items corresponding to the abnormalities. For example, when the item associated with one abnormality is not indicated by circles, but the item associated with the other abnormality is indicated by a circle, the data corresponding to the items is stored into the regular storage medium 92 and the saving storage medium 93.

### (Thirteenth Variation)

Next, the thirteenth variation of the data storage device 90 according to the first embodiment will be described.

When the abnormality detector 910 detects an abnormal state and when a predetermined trigger event occurs, the controller 911 according to the present variation shortens a temporal interval at which data such as the determination information is stored into the saving storage medium 93. Hereinafter, the temporal interval of data that is stored into the saving storage medium 93 will be referred to as a “sampling interval”. Furthermore, the temporal period of data that is stored into the saving storage medium 93 will be referred to as a “sampling period”.

As the trigger event, the aforementioned events indicated in (d1) to (d6) can be used, for example. Furthermore, as the trigger event, switching from the manual drive mode to the autonomous drive mode, execution of the TOR, execution of the MRM, and transfer of the authority of driving from the autonomous driving ECU 70 to an occupant can be used, for example.

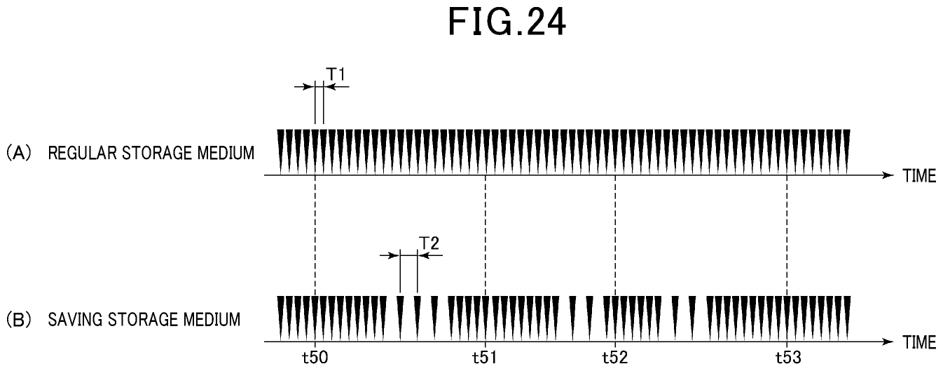

For example, assume that the event of transferring the authority of driving from the autonomous driving ECU 70 to an occupant is used as the trigger event. In addition, assume that the controller 911 causes the regular storage medium 92 to store data at a first storage interval T1, as shown in (A) in FIG. 24. The inverted triangular mark in (A) and (B) in FIG. 24 indicates data storage timing. In this case, as shown in (B) in FIG. 24, when the abnormality detector 910 detects an abnormal state at time t50, t51, t53 and the event of transferring the authority of driving from the autonomous driving ECU 70 to an occupant occurs at time t52, the controller 911 causes the saving storage medium 93 to store the data stored in the regular storage medium 92, in predetermined periods before and after time t50 to t53. Furthermore, in periods other than the predetermined periods before and after time t50 to t53, the controller 911 causes the saving storage medium 93 to store the data stored in the regular storage medium 92, at a second storage interval T2, which is longer than the first storage interval T1. With such a configuration, when the abnormality detector 910 detects an abnormal state and when a trigger event occurs, the sampling interval of the data in the saving storage medium 93 can be shortened.

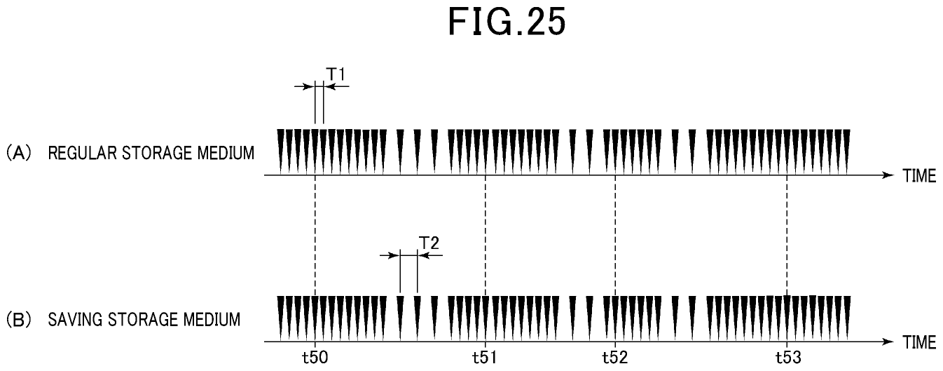

Alternatively, as shown in (A) in FIG. 25, the controller 911 may cause the regular storage medium 92 to store data at the first storage interval T1, in periods before and after time t50 to t53, and cause the regular storage medium 92 to store the determination information at the second storage interval T2, in the other periods. In this case, as shown in (B) in FIG. 25, the controller 911 causes the saving storage medium 93 to directly store the data stored in the regular storage medium 92. Even with such a configuration, when the abnormality detector 910 detects an abnormal state and when a trigger event occurs, the sampling interval of the data in the saving storage medium 93 can be shortened.

With the data storage device 90 according to the present variation, the accuracy in analyzing the subject driving the vehicle before and after the occurrence of an abnormality and before and after the occurrence of a trigger event can be improved. Furthermore, the data usage of the saving storage media 93 can be reduced, and thus the determination information can be stored into the saving storage medium 93 for a longer length of time.

### (Fourteenth Variation)

Next, the fourteenth variation of the data storage device 90 according to the first embodiment will be described.

For example, switching from the manual drive mode to the autonomous drive mode, execution of the TOR, execution of the MRM, and transfer of the authority of driving from the autonomous driving ECU 70 to an occupant require different lengths of time until the control thereon becomes stable. Thus, at a point when the trigger event occurs, the controller 911 according to the present embodiment changes at least one of the sampling interval of data and the sampling period of data in the regular storage medium 92 and the saving storage medium 93.

The time required until the control becomes stable depends, for example, on what type of abnormality has occurred in the vehicle 10 or where an abnormality has occurred in the vehicle 10. Therefore, the controller 911 may change at least one of the sampling interval of data and the sampling period of data in the regular storage medium 92 and the saving storage medium 93 according to the type of the abnormality or where the abnormality is located, for example.

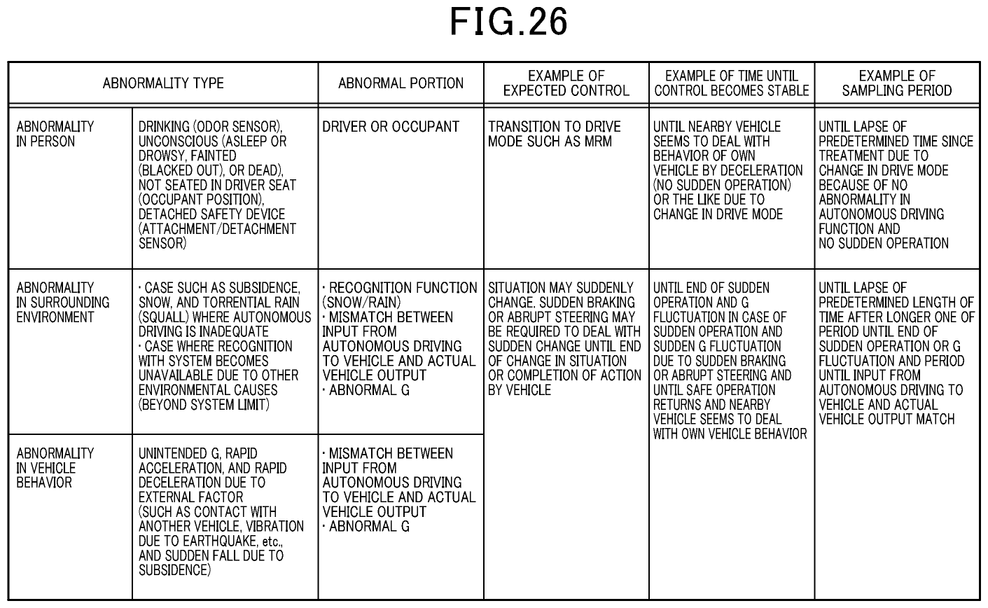

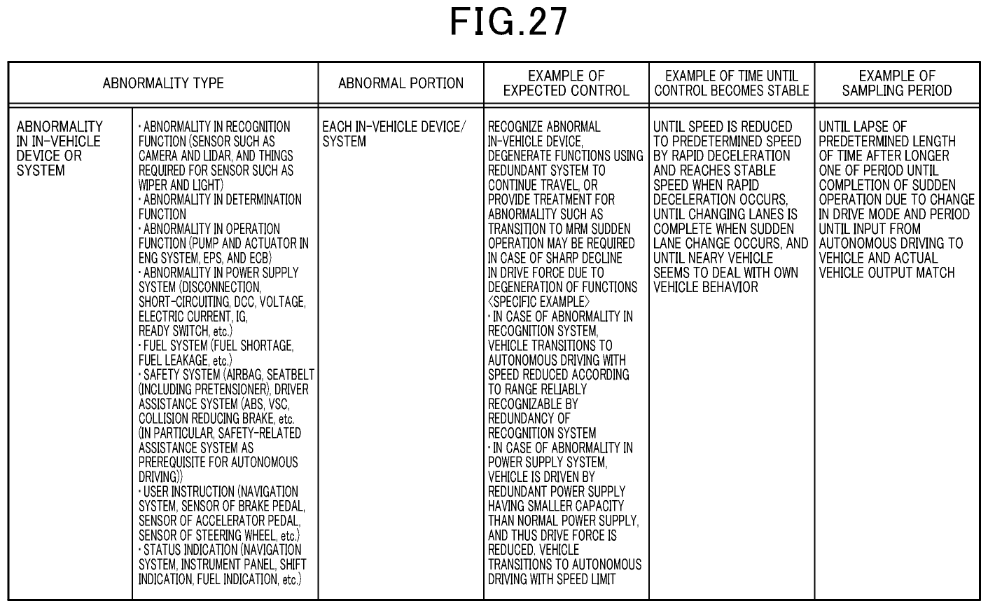

Specifically, when an abnormality such as those listed in the columns “ABNORMALITY TYPE” and “ABNORMAL PORTION” in FIGS. 26 and 27 occurs, it is expected that the control such as those listed in the column “EXAMPLE OF EXPECTED CONTROL” is performed in the vehicle 10. In this case, the time such as those listed in the column “EXAMPLE OF TIME UNTIL CONTROL BECOMES STABLE” is required until the control becomes stable. In the exemplary cases listed herein, the controller 911 makes the sampling interval shorter than usual in the period listed in the column “EXAMPLE OF SAMPLING PERIOD”.

Furthermore, in the case where an abnormality that has occurred in the vehicle 10 is an abnormality in the behavior of the vehicle 10 or an abnormality in a device required to perform the autonomous driving control, the sampling interval of data in the regular storage medium 92 and the saving storage medium 93 is shortened in order to check whether an abnormality has occurred in the autonomous driving control. For example, in the case where an abnormality that may quickly affect the autonomous driving control occurs such as the case where an abnormality occurs in the surrounding recognition sensor 71 for recognition, the EPS 40 for operation, or the like, the sampling interval of data in the regular storage medium 92 and the saving storage medium 93 is shortened. In other words, data is frequently stored into the regular storage medium 92 and the saving storage medium 93.

In contrast, in the case of an abnormal state of a person or an abnormality in a device for a person to operate, the sampling interval of data in the regular storage medium 92 and the saving storage medium 93 is extended assuming that the autonomous driving control has no problem. For example, in the case where the driver is asleep, a fuel system is running short of fuel, the shift indication is abnormal, or the wiper is abnormal, the sampling interval of data in the regular storage medium 92 and the saving storage medium 93 is extended because the autonomous driving control can remain normal for the time being. In other words, data is less frequently stored into the regular storage medium 92 and the saving storage medium 93.

### (Fifteenth Variation)

Next, the fourteenth variation of the data storage device 90 according to the first embodiment will be described.

As indicated by the dashed line in FIG. 2, the processor 91 further includes a travel condition detector 912. On the basis of various kinds of information acquired from the ECUs 20 to 70, the travel condition detector 912 detects a vehicle travel condition such as a traffic lane in which the vehicle 10 is traveling and the state of a road surface on which the vehicle 10 is traveling.

When determining that the travel condition of the vehicle 10 detected by the travel condition detector 912 needs to be analyzed with high priority, the controller 911 according to the present variation shortens the sampling interval of data in the regular storage medium 92 and the saving storage medium 93 or extends the sampling period of data in the regular storage medium 92 and the saving storage medium 93.

The condition in great need of analysis is a situation in which the vehicle 10 is traveling against the flow of nearby vehicles or a situation in which the vehicle 10 is traveling on a road having poor surface condition. Examples of the situation in which the vehicle 10 is traveling against the flow of nearby vehicles include a situation in which the vehicle 10 is changing lanes, a situation in which a traffic lane in which the vehicle 10 is traveling merges into a different traffic lane, a situation in which the vehicle 10 is traveling through an intersection, and a situation in which the vehicle is turning right or left. Examples of the situation in which the vehicle 10 is traveling on a road having poor surface condition include a situation in which the vehicle 10 is traveling on a snowy road, a situation in which the vehicle 10 is traveling at a temperature of at most below the freezing point where the road surface may freeze, a situation in which the vehicle 10 is traveling in the rain, a situation in which the vehicle 10 is traveling through a puddle, and a situation in which the vehicle 10 is traveling on a bumpy road. Furthermore, the condition in great need of analysis also includes a situation in which the vehicle 10 is traveling on an expressway, for example.

### Second Embodiment

Next, the data storage device 90 according to the second embodiment will be described. The following focuses on description of differences from the data storage device 90 according to the first embodiment.

As indicated by the dashed line in FIG. 1, the vehicle 10 according to the present embodiment includes a communication device 100 capable of communicating at least one of another vehicle 110 and a management center 120.

The management center 120 is an organization that provides a data storage service separately from the own vehicle 10. In the management center 120, data of two or more vehicles can be stored, or data can be stored for a long time, for example. Examples of the management center 120 include a public management center and a private management center. The public management center is an organization capable of exchanging communication data without limitations on the vehicle type and usage or is an organization available exclusively for service subscribers. The private management center is an organization for specific vehicles in a company or the like or is stored in an individually-owned personal computer or the like.

The method for communication with the management center 120 is wireless communication. As the method for communication with the management center 120, a method for transmission from the vehicle to the management center 120 via a personal computer or the like is also usable.

The communication device 100 is connected to each of the ECUs 20 to 70 and the data storage device 90 via the in-vehicle network 80 so as to be able to communicate with one another. Therefore, each of the ECUs 20 to 70 and the data storage device 90 is capable of transmitting data to at least one of another vehicle 110 and the management center 120 through the communication device 100.

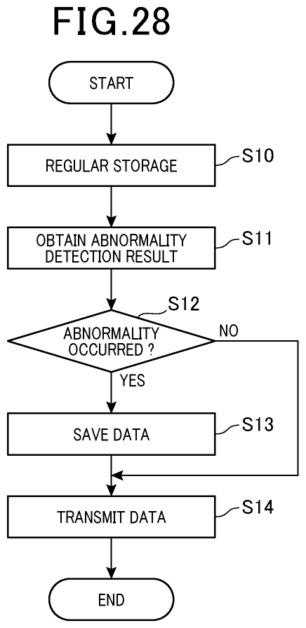

As shown in FIG. 28, when the process in step S13 is performed or when a negative determination is made in the process in step S12, the controller 911 transmits the data stored in the regular storage medium 92 or the saving storage medium 93 to at least one of another vehicle 110 and the management center 120 through the communication device 100 as a process in step S14. This data includes the determination information of the vehicle 10. Thus, the determination information of the own vehicle 10 can be stored in another vehicle 110 and the management center 120.

The determination information transmitted from the controller 911 to at least one of another vehicle 110 and the management center 120 includes vehicle identification information in the management information shown in FIG. 6. Thus, when at least one of the own vehicle 110 and the management center 120 receives the determination information, a vehicle corresponding to the received determination information can be identified.

With the data storage device 90 according to the present embodiment described above, the effects indicated in (3) and (4) below can be acquired.

(3) Even when an abnormality occurs in the saving storage medium 93 or when the data usage of the saving storage medium 93 reaches the upper limit of storage capacity, the determination information of the own vehicle can be stored in another vehicle 110 and the management center 120. Furthermore, as a result of storing the determination information of the own vehicle into the management center 120, the determination information can be quickly analyzed in the management center 120, and thus checking an abnormal state is facilitated. Moreover, since the situation of being unable to transmit the determination information to the management center 120 is conceivable, transmitting the determination information to the other vehicle 110 allows the determination information to be more accurately saved.

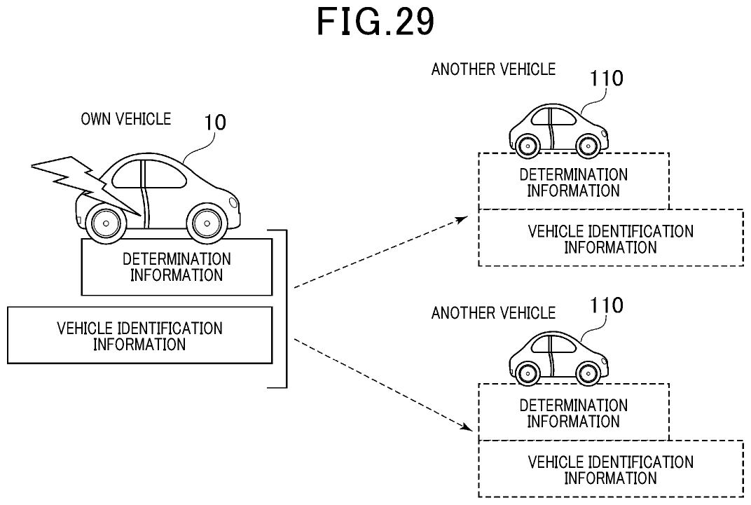

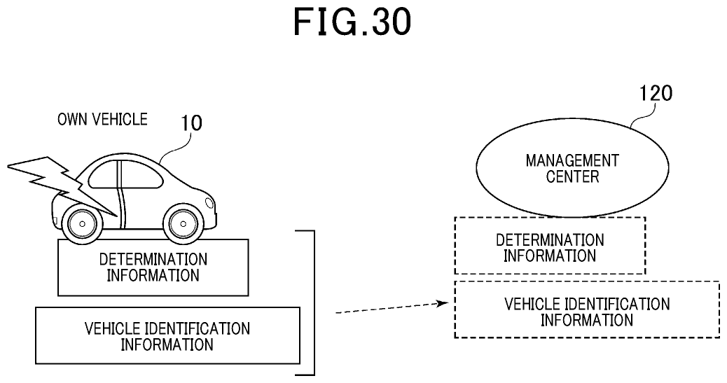

(4) As shown in FIG. 29, when an abnormality occurs in the vehicle 10, the determination information is transmitted from the vehicle 10 to another vehicle 110 together with the vehicle identification information, and thus the vehicle corresponding to the received determination information can be easily identified in another vehicle 110. Similarly, as shown in FIG. 30, when an abnormality occurs in the vehicle 10, the determination information is transmitted from the vehicle 10 to the management center 120 together with the vehicle identification information, and thus the vehicle corresponding to the received determination information can be easily identified also in the management center 120.

### (First Variation)

Next, the first variation of the data storage device 90 according to the second embodiment will be described.

The controller 911 according to the present variation changes the sampling interval of data in the regular storage medium 92 and the saving storage medium 93 according to a data transmission destination. For example, in the case where transmission of data such as the determination information requires long hours due to limitations on the speed, amount, etc., of transmission to the transmission destination or in the case where the upper limit of storage capacity of the transmission destination is low, the sampling interval of the data in the regular storage medium 92 or the saving storage medium 93 may be extended.

### (Second Variation)

Next, the second variation of the data storage device 90 according to the second embodiment will be described.

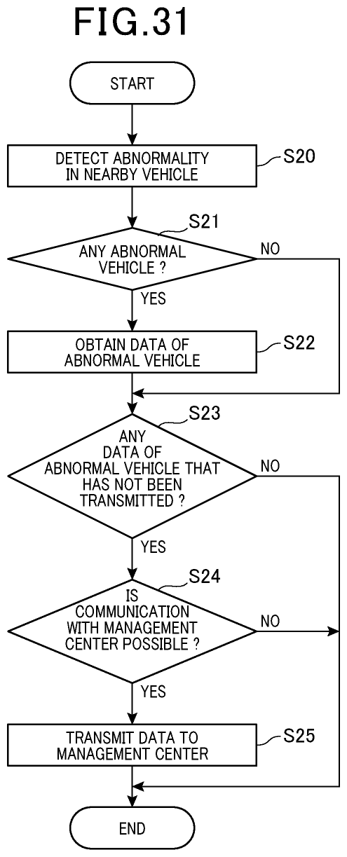

In the present variation, the controller 911 of another vehicle 110 that receives data such as the determination information transmitted from the vehicle 10 performs the processes indicated in FIG. 31. The controller 911 of another vehicle 110 performs, in a predetermined cycle, the processes indicated in FIG. 31.

As shown in FIG. 31, the controller 911 first detects an abnormality in a nearby vehicle as a process in step S20. Specifically, the controller 911 detects an abnormality in a nearby vehicle on the basis of reception of an abnormality signal via V2V, the management center 120, etc. Alternatively, the controller 911 detects an abnormality in a nearby vehicle on the basis of detection of a nearby abnormal traveling vehicle using sensors such as a microphone and the surrounding recognition sensor 71 of the autonomous driving ECU 70. The nearby abnormal traveling vehicle is, for example, a vehicle with lights indicating an abnormality such as hazards on, a vehicle slower than other preceding and following vehicles, or a vehicle traveling on a road shoulder.

As a process in step S21, the controller 911 determines, on the basis of the detection result in step S20, whether any abnormal vehicle is present nearby. In other words, when an abnormal vehicle is detected in the process in step S20, the controller 911 determines that an abnormal vehicle is present nearby. When no abnormal vehicle is detected in the process in step S20, the controller 911 determines that no abnormal vehicle is present nearby. When an affirmative determination is made in the process in step S21, that is, when an abnormal vehicle is present nearby, the controller 911 acquires data from the abnormal vehicle as a process in step S22. This data includes the determination information of the abnormal vehicle.

After performing the process in step S22, the controller 911 determines, as a process in step S23, whether there is any data of the abnormal vehicle that has not been transmitted to the management center 120. The controller 911 performs the process in step S23 even when making a negative determination in the process in step S21, that is, even when no abnormality has been detected in the nearby vehicle.

When making an affirmative determination in the process in step S23, that is, when there is data of the abnormal vehicle that has not been transmitted to the management center 120, the controller 911 determines, as a process in step S24, whether communication with the management center 120 is possible. When making an affirmative determination in the process in step S24, that is, when communication with the management center 120 is possible, the controller 911 transmits the data of the abnormal vehicle to the management center 120 as a process in step S25, and ends a series of processes.

When making a negative determination in the process in step S23 or when making a negative determination in the process in step S24, the controller 911 ends a series of processes.

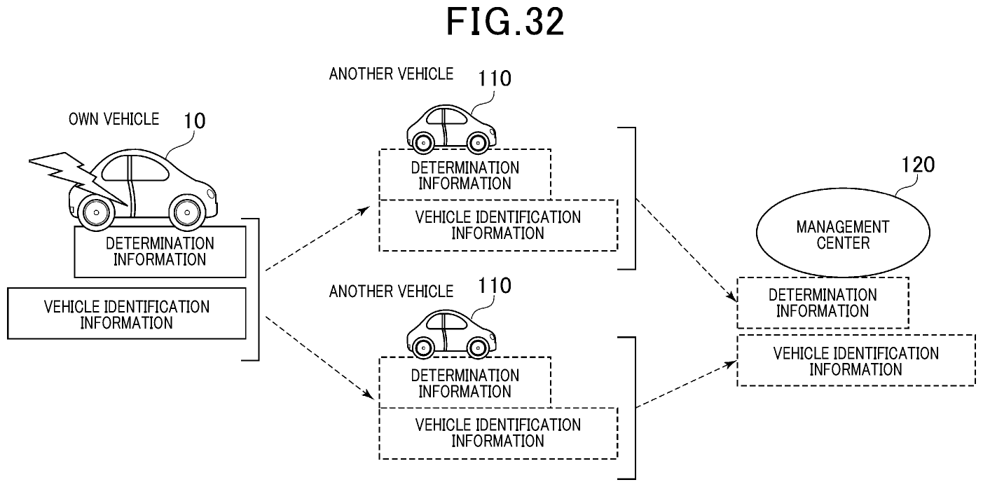

With this configuration, as shown in FIG. 32, data such as the determination information transmitted from the vehicle 10 in which an abnormality has occurred is transmitted to the management center 120 via another vehicle 110. Thus, even in a situation in which the vehicle 10 is traveling deep in mountains or a situation in which communication or data storage is not possible due to an abnormality in the storage media 92, 93, when another vehicle 110 traveling nearby moves to a spot where communication is possible, data such as the determination information can be transmitted to the management center 120. Furthermore, as a result of data such as the determination information being partially held by each of a plurality of other vehicles 110 and as a result of said information being transmitted to and integrated in the management center 120, a large amount of data such as the determination information can be stored into an external unit.

### (Third Variation)

Next, the third variation of the data storage device 90 according to the second embodiment will be described.

The data storage device 90 according to the present variation has the same configuration as the configuration of the data storage device 90 shown in FIG. 19. In other words, the data storage device 90 has the regular storage medium 92 only. The controller 911 causes the regular storage medium 92 to store data such as one-trip or several-trip determination information. Furthermore, after completion of the data storage into the regular storage medium 92, the controller 911 transmits the whole or a part of the data such as one-trip or several-trip determination information to the management center 120.

### Third Embodiment

Next, the data storage device 90 according to the third embodiment will be described. The following focuses on description of differences from the data storage device 90 according to the first embodiment.

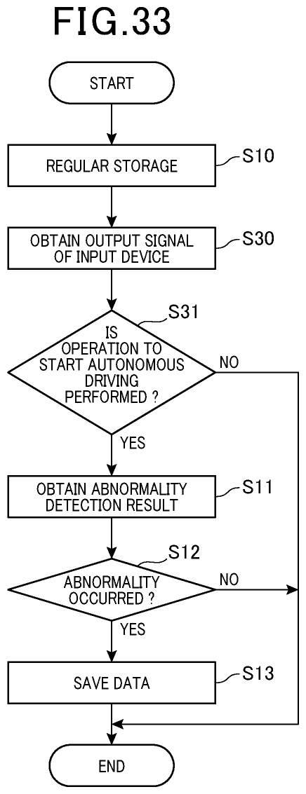

The controller 911 according to the present embodiment repeatedly performs the processes shown in FIG. 33 in a predetermined cycle. In the processes shown in FIG. 33, the same processes as the processes shown in FIG. 3 are denoted by the same reference signs; thus, overlapping description will be omitted.

As shown in FIG. 33, after causing the regular storage medium 92 to store the determination information as a process in step S10, the controller 911 acquires an output signal of the input device 72 as a process in step S30. Furthermore, as a process in step S31, the controller 911 determines, on the basis of the output signal of the input device 72, whether the operation to start autonomous driving has been performed.

When making an affirmative determination in the process in step S31, the controller 911 acquires the abnormality detection result from each of the ECUs 20 to 70 as a process in step S11 and causes the regular storage medium 92 to store information corresponding to the acquired abnormality detection result. Thereafter, as a process in step S12, the controller 911 determines, on the basis of the abnormality detection result acquired from each of the ECUs 20 to 70, whether the vehicle 10 has an abnormality. When making an affirmative determination in the process in step S12, that is, when the vehicle 10 has an abnormality, the controller 911 copies the data stored in the regular storage medium 92 to the one or more saving storage media 93 as a process in step S13. Specifically, the controller 911 copies the data stored in the regular storage medium 92 to the one or more saving storage media 93 in a predetermined length of time after reference time, where the reference time represents time the predetermined length of time back from time at which the operation to start autonomous driving is performed.

After performing step S13, the controller 911 ends this iteration of the processing. When making a negative determination in the process in step S31 or when making a negative determination in the process in step S12, the controller 911 ends a series of processes.

With the data storage device 90 according to the present embodiment described above, the effects indicated in (5) below can be acquired in addition to the effects indicated in (1) in the first embodiment.

(5) When the abnormality detector 910 detects an abnormal state upon switching of the drive mode of the vehicle 10 from the manual drive mode to the autonomous drive mode, the controller 911 causes the saving storage media 93 to store the determination information. Thus, even when an abnormality occurs in the vehicle 10 upon switching of the drive mode of the vehicle 10 from the manual drive mode to the autonomous drive mode, whether the subject driving the vehicle upon the occurrence of the abnormality is a person or the autonomous driving control device can be easily analyzed.

### Fourth Embodiment

Next, the data storage device 90 according to the fourth embodiment will be described. The following focuses on description of differences from the data storage device 90 according to the first embodiment.

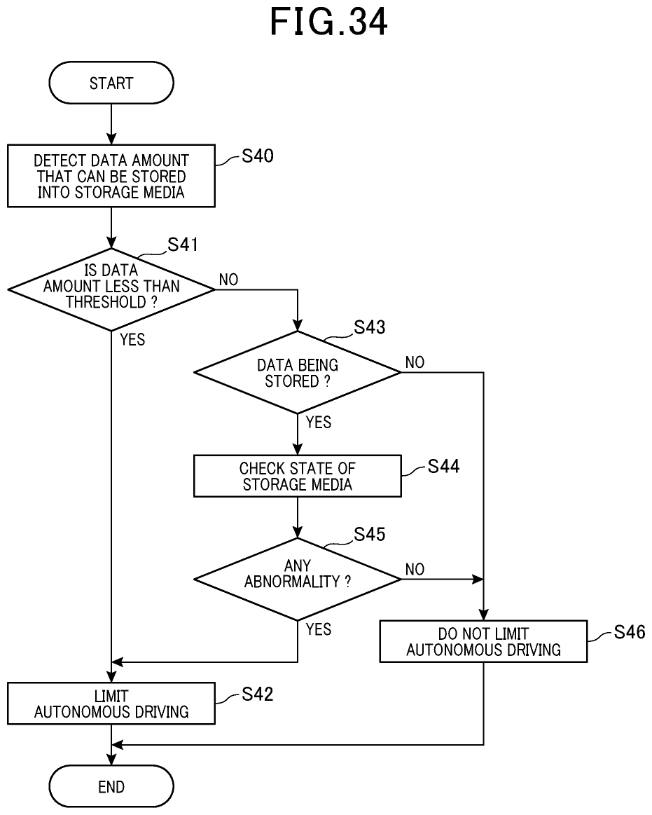

The controller 911 according to the present embodiment repeatedly performs the processes shown in FIG. 34 in a predetermined cycle. As shown in FIG. 34, the controller 911 first detects, as a process in step S40, a data amount that can be stored into the storage media 92, 93, and then determines, as a process in step S41, whether the data amount is less than a predetermined threshold. When making an affirmative determination in the process in step S41, that is, when the data amount that can be stored into the storage media 92, 93 is less than the threshold, the controller 911 limits the autonomous driving function of the vehicle 10 as step S42. For example, as a limitation on the autonomous driving function, the controller 911 executes at least one of the following actions (e1) to (e3).

(e1) Prohibiting autonomous driving.

(e2) Prohibiting autonomous driving while no occupant is on board.

(e3) Permitting partial autonomous driving that requires a driver to operate. For example, the controller 911 permits at least one of lane keeping, traction control, cruise control, and automatic brake systems.

When making a negative determination in the process in step S41, that is, when the data amount that can be stored into the storage media 92, 93 is greater than or equal to the threshold, the controller 911 determines, as a process in step S43, whether data is being stored into the storage media 92, 93. When making a negative determination in the process in step S43, that is, when no data is being stored into the storage media 92, 93, the controller 911 does not limit the autonomous driving function as a process in step S46.

When making an affirmative determination in the process in step S43, that is, when data is being stored into the storage media 92, 93, the controller 911 checks the state of the storage media 92, 93 as a process in step S44. Specifically, the controller 911 checks those listed in (f1) to (f3) below.

(f1) Checking the RAM and the ROM.

(f2) Checking, by performing test writing and test reading, whether data is successfully stored into the regular storage medium 92 and the saving storage media 93.

(f3) Checking the regular storage medium 92 at the start of the vehicle 10 and checking the saving storage media 93 on a regular basis while data storage is suspended.

Subsequently, as a process in step S45, the controller 911 determines, on the basis of the checking result in step S44, whether the storage media 92, 93 have an abnormality. When making an affirmative determination in the process in step S45, that is, when the storage media 92, 93 have an abnormality, the controller 911 limits the autonomous driving function as a process in step S42. When making a negative determination in the process in step S45, that is, when the storage media 92, 93 have no abnormalities, the controller 911 does not limit the autonomous driving function as a process in step S46.

With the data storage device 90 according to the present embodiment described above, the effects indicated in (6) below can be acquired.

(6) When the storage media 92 and 93 have an abnormality, the controller 911 limits the autonomous driving function of the vehicle 10. Furthermore, also when the data amount that can be stored into the storage media 92, 93 is less than the predetermined threshold, the controller 911 limits the autonomous driving function of the vehicle 10. Thus, in a situation in which storing the determination information into the storage media 92, 93 is difficult, the vehicle 10 travels to ensure safety.

### Fifth Embodiment

Next, the data storage device 90 according to the fifth embodiment will be described. The following focuses on description of differences from the data storage device 90 according to the first embodiment.

In the case of leaving the entire determination information in the saving storage medium 93, if the vehicle 10 continues traveling, the data usage of the storage media 92, 93 reaches the upper limit of storage capacity, and thus the data stored in the storage media 92, 93 need to be deleted. Thus, the controller 911 according to the present embodiment deletes a part or the whole of the data stored in the storage media 92, 93, at deletion timing listed in (g1) to (g5) below.

(g1) Upon the lapse of a predetermined length of time.

(g2) At a point when the data usage exceeds a predetermined threshold.

(g3) At a point when an occupant, a dealer, or the like makes a delete instruction.

(g4) At a point when the vehicle 10 is supplied with fuel or electricity.

(g5) At a point when the vehicle 10 has traveled several trips after the last deletion timing.

The controller 911 may set data as deletable in the aforementioned deletion timing, and when the data usage of the storage media 92, 93 reaches the upper limit of storage capacity, delete the data in order of predetermined priorities. The order of predetermined priorities is determined as indicated in (h1) to (h5) below, for example.

(h1) Deleting data in chronological order of trips.

(h2) Preferentially deleting data that has been transferred to the outside of the vehicle.

(h3) Setting the order of priorities according to triggers leading to recording.

(h4) Preferentially deleting data of a nearby vehicle.

(h5) When the need for deleting the data stored in the saving storage media 93 arises, notifying an occupant to that effect, and deleting the data according to the permit from the occupant. The occupant may select data to be deleted.

Examples of the trigger indicated in the above (h3) include events listed in (i1) to (i6) below.

(i1) Transfer of the authority of driving to an occupant.

(i2) Transition to the autonomous drive mode. For example, the case where a driver provides an instruction about transition to the autonomous drive mode after an abnormality occurs in the vehicle 10.

(i3) Inability of the autonomous driving ECU 70 to recognize an obstacle or the like. For example, the case beyond the recognition limit of the autonomous driving ECU 70.

(i4) Occurrence of an abnormality that impedes autonomous driving. For example, the case where an abnormality occurs in a device or recognition is made impossible due to snow or the like.

(i5) Occurrence of an abnormality in a driver. For example, the case where the driver is unconscious, intoxicated, or does not wear the seatbelt.

(i6) Detection of an abnormal value of lateral acceleration of the vehicle 10, unintended rapid acceleration or rapid deceleration of the vehicle 10, or the like.

Furthermore, the controller 911 may provide priorities to the data stored in the storage media 92, 93 and delete the data in order from the lowest priority. Examples of a method for providing priorities include a method for providing priorities so that, for example, an abnormality in the behavior of the vehicle, the first abnormality, and a midstream abnormality have higher priorities in this order. Alternatively, the priorities may be provided by methods indicated in (j1) to (j3) below.

(j1) Scoring the data in order from the lowest priority.

(j2) Scoring the data according to time elapsed from storage.

(j3) Ranking the data for priorities using multiplication of the priority level and the number of days elapsed.

Meanwhile, deletion of data from the storage media 92, 93 in response to an external command is limited. External indicates at least one of an occupant, the management center 102, and a dealer. As a method for limiting deletion of the data stored in the storage media 92, 93, at least one of the methods listed in (k1) to (k3) below is used, for example.

(k1) Entirely prohibiting data deletion.

(k2) Partially prohibiting data deletion.

(k3) Permitting deletion of only the data stored in the regular storage medium 92. Prohibiting deletion of the data stored in the saving storage media 93.

Furthermore, upon the partial data deletion indicated in the above (k2), a method for prohibiting data deletion depending on the trigger leading to data storage can be used, for example. The partial data deletion is performed, for example, by methods indicated in (m1) and (m2) below.

(m1) Prohibiting deletion of the determination information stored according to a predetermined trigger. For example, deletion of the determination information stored according to the triggers indicated in (d1) to (d6) according to the fifth variation of the first embodiment is prohibited.

(m2) Prohibiting deletion of the data corresponding to a trip in which a predetermined trigger occurs or the data corresponding to the period between the occurrence of a trigger and the end of a trip. For example, deletion of the determination information corresponding to a trigger that is likely to require analysis later on is prohibited. Examples of the trigger that is likely to require analysis later on include events listed in (n1) and (n2) below.

(n1) Detection of an abnormal value of lateral acceleration of the vehicle 10, unintended rapid acceleration or rapid deceleration of the vehicle 10, or the like.

(n2) Occurrence of an abnormality in a driver. For example, the case where the driver is unconscious, drunk, or does not wear the seatbelt.

Persons authorized to delete the data stored in the storage media 92, 93 may be limited to, for example, a dealer, the management center 120, or the like.

Furthermore, the method for deleting the data stored in the storage media 92, 93 may be limited. For example, in the case where the data can be deleted from the outside, methods indicated in (p1) to (p3) below can be used.

(p1) Requiring a separate device for deletion.

(p2) Requiring a password, hardware serving as a key, or both of these upon deletion.

(p3) Not permitting deletion in the period until the lapse of a predetermined length of time.

Furthermore, in the case where the data cannot be deleted from the outside, a method in which no button or signal for data deletion is provided on the data storage device 90 can be used, for example.

With the data storage device 90 according to the present embodiment described above, the effects indicated in (7) and (8) below can further be acquired.

(7) As a result of deleting the data stored in the storage media 92, 93, important data required to analyze the subject driving the vehicle can be left while increasing the data usage of the storage media 92, 93.

(8) Deletion of data from the storage media 92, 93 in response to an external command is limited. Thus, loss of the important data can be prevented.

### Sixth Embodiment

Next, the data storage device 90 according to the sixth embodiment will be described. The following focuses on description of differences from the data storage device 90 according to the first embodiment.

Instead of the method for detecting an abnormality in the vehicle 10, an abnormality of an occupant, and an abnormality in the environment surrounding the vehicle 10, the abnormality detector 910 according to the present embodiment predicts whether these abnormalities will occur. Specifically, on the basis of the output value of each of the sensors 73, 77 and the switches 74 to 76 and information that can be acquired from each of the ECUs 20 to 70, the abnormality detector 910 predicts whether an abnormality will occur in the vehicle 10. When the abnormality detector 910 predicts the occurrence of an abnormality in the vehicle 10, the controller 911 copies the determination information stored in the regular storage medium 92 to the saving storage medium 93.

For example, on the basis of the state of an occupant detected by the in-vehicle ECU 60 using the occupant monitor sensor 62, the abnormality detector 910 predicts whether there is a probability that an abnormality will occur in the occupant. Examples of the state of an occupant include the occupant body temperature, face recognition, line-of-sight recognition, and voice conversation in the vehicle 10.

Furthermore, when the hours of use, the frequency of occurrence, or the like that has a gradually changing value such as deterioration exceeds a predetermined threshold, the abnormality detector 910 predicts that there is a probability that an abnormality will occur in an in-vehicle device and an in-vehicle system. For example, when detecting a decrease in the air pressure of a tire due to a blowout or natural deterioration, the abnormality detector 910 predicts that there is a probability that a problem with driving will arise within a predetermined length of time. Furthermore, when detecting a fuel shortage, the abnormality detector 910 predicts that a problem with driving will arise within a predetermined length of time.

Furthermore, when determining that there will be rain, snow, or an earthquake according to the V2V, V2X, weather information, emergency information, etc., the abnormality detector 910 predicts that there is a probability that an abnormality will occur in the surrounding environment.

In addition, on the basis of the pre-crash sensor 54, the surrounding recognition sensor 71 including a camera and a lidar device, V2V communication, etc., the abnormality detector 910 predicts abnormal behavior of the vehicle 10 or determines that abnormal behavior of the vehicle 10 cannot be avoided.

With the data storage device 90 according to the present embodiment described above, the effects indicated in (9) below can be acquired.

(9) The abnormality detector 910 predicts whether an abnormality will occur in the vehicle 10. When the abnormality detector 910 predicts that an abnormality will occur in the vehicle 10, the controller 911 causes the saving storage medium 93 to store data such as the determination information stored in the regular storage medium 92. Thus, even in the case where the MRM has started as a result of the autonomous driving ECU 70 predicting, according to abnormal behavior, etc., of the vehicle 10, that there is a probability that an abnormality will occur in the vehicle 10, when an abnormality occurs in the vehicle 10 afterwards, the determination information is stored into the saving storage medium 93. In such a situation, the driver may erroneously recognize evacuation travel of the vehicle 10 as an abnormality in the vehicle 10; therefore, by leaving grounds for the MRM and records of the behavior in the saving recording medium 93 as the determination information, whether the vehicle 10 actually has the abnormality can be analyzed.

### Other Embodiments

Each embodiment can be implemented in the following form.

The vehicle 10 is not limited to a vehicle powered by the engine 21 only and may be a vehicle powered by a motor generator, which is, for example, a hybrid vehicle, an electric car, or a fuel cell vehicle. In the vehicle 10 of this kind, a motor generator ECU 130 which controls a motor generator 131 is mounted as indicated by the dashed line in FIG. 1.

The configuration of the data storage device 90 described in each variation of the first embodiment can be applied to the data storage device 90 according to each of the second to sixth embodiments.

The means and/or functions provided by the processor 91 can be provided using software stored on a tangible storage medium, a computer that executes the software, only software, only hardware, or a combination of these elements. For example, in the case where the processor 91 is provided using an electronic circuit which is hardware, this can be provide using an analog circuit or a digital circuit including multiple logic circuits.

The present disclosure is not limited to the above-described specific examples. Modifications resulting from appropriate design changes applied by a person having ordinary skill in the art to the above-described specific examples are also included in the scope of the present disclosure as long as the modifications have the features of the present disclosure. The elements, the arrangement of the elements, the conditions, the shapes, and the like of each of the above-described specific examples are not necessarily limited to those exemplified and can be appropriately changed. A combination of the respective elements included in each of the above-described specific examples can be appropriately changed as long as no technical inconsistency exists.

What is claimed is:

1. A data storage device mounted on a vehicle on which an autonomous driving control device performs an autonomous driving control, the data storage device comprising:
an abnormality detector that detects an abnormal state including at least one of an abnormality in the vehicle, an abnormality in an occupant of the vehicle, and an abnormality in a surrounding environment of the vehicle; and
a controller that, when the abnormality detector detects the abnormal state, causes a storage medium to store determination information allowing for determination of whether a subject driving the vehicle is the autonomous driving control device, wherein
the determination information includes at least one of a control amount of the autonomous driving control, basis information for the control amount, an operation amount of the vehicle, actual output information of the vehicle, and information directly indicating whether autonomous driving is ON.

2. The data storage device of the vehicle according to claim 1, wherein:
the controller causes the storage medium to store the determination information that has been acquired in a period until a lapse of a predetermined length of time after a reference time which is set on the basis of time at which the abnormality detector detects the abnormal state.

3. The data storage device of the vehicle according to claim 2, wherein:
in a period until a lapse of the predetermined length of time after a point in time when the abnormality detector detects the abnormal state, when the abnormality detector further detects an abnormality, the controller extends the predetermined length of time.

4. The data storage device of the vehicle according to claim 1, wherein
when a drive mode of the vehicle is switched from an autonomous drive mode to a manual drive mode after the abnormality detector detects the abnormal state, the controller suspends storage of the determination information into the storage medium.

5. The data storage device of the vehicle according to claim 1, wherein:
when causing the storage medium to store the determination information that has been acquired in a period until a lapse of a predetermined length of time after a reference time which is set on the basis of time at which the abnormality detector detects the abnormal state, the controller makes a temporal sampling interval shorter than in a period different from the period until the lapse of the predetermined length of time after the reference time, the temporal sampling interval being an interval at which the determination information is stored into the storage medium.

6. The data storage device of the vehicle according to claim 1, wherein:
when detecting the abnormal state in a situation in which the autonomous driving of the vehicle is ON, the abnormality detector changes at least one of a temporal sampling interval and a temporal sampling period according to a type of an abnormality that has been detected, the temporal sampling interval being an interval at which the determination information is stored into the storage medium, the temporal sampling period being a period in which the determination information is stored into the storage medium.

7. The data storage device of the vehicle according to claim 1, further comprising:
a travel condition detector that detects a travel condition of the vehicle, wherein
the abnormality detector changes a temporal sampling interval and a temporal sampling period on the basis of the travel condition of the vehicle that has been detected by the travel condition detector, the temporal sampling interval being an interval at which the determination information is stored into the storage medium, the temporal sampling period being a period in which the determination information is stored into the storage medium.

8. The data storage device of the vehicle according to claim 1, wherein:
when the abnormality detector detects the abnormal state upon switching of a drive mode of the vehicle from a manual drive mode to an autonomous drive mode, the controller causes the storage medium to store the determination information.

9. The data storage device of the vehicle according to claim 1, wherein:
when the storage medium has an abnormality, the controller limits an autonomous driving function of the vehicle.

10. The data storage device of the vehicle according to claim 1, wherein:
when data usage of the storage medium is less than a predetermined threshold, the controller limits an autonomous driving function of the vehicle.

11. The data storage device of the vehicle according to claim 1, wherein:
the controller transmits the determination information stored in the storage medium to a storage medium located outside the vehicle.

12. The data storage device of the vehicle according to claim 1, wherein:
the abnormality detector detects, as an abnormality in the vehicle, at least one of an abnormality in an in-vehicle device or an in-vehicle system that is controlled according to the autonomous driving control, an abnormality in behavior of the vehicle, and an abnormality in a redundant system of the in-vehicle device or the in-vehicle system.

13. The data storage device of the vehicle according to claim 1, wherein:
deletion of data from the storage medium in response to an external command is limited.

14. A data storage device mounted on a vehicle on which an autonomous driving control device performs an autonomous driving control, the data storage device comprising:
an abnormality detector that detects an abnormal state including at least one of an abnormality in the vehicle, an abnormality in an occupant of the vehicle, and an abnormality in a surrounding environment of the vehicle; and
a controller that, when the abnormality detector predicts entry into the abnormal state, causes a storage medium to store determination information allowing for determination of whether a subject driving the vehicle is the autonomous driving control device, wherein
the determination information includes at least one of a control amount of the autonomous driving control, basis information for the control amount, an operation amount of the vehicle, actual output information of the vehicle, and information directly indicating whether autonomous driving is ON.

15. The data storage device of the vehicle according to claim 14, wherein:
deletion of data from the storage medium in response to an external command is limited.
